(19) United States
(12) Patent Application Publication
(10) Pub. No.: US 2022/0350024 A1
(43) Pub. Date: Nov. 3, 2022

(54) DISTANCE IMAGE CAPTURING DEVICE AND DISTANCE IMAGE CAPTURING METHOD

(71) Applicant: Brookman Technology, Inc., Hamamatsu-shi, Shizuoka (JP)

(72) Inventor: Keigo Isobe, Hamamatsu-shi (JP)

(21) Appl. No.: 17/621,459

(22) PCT Filed: Jul. 4, 2019
(86) PCT No.: PCT/JP2019/026560

§ 371 Date: Dec. 21, 2021

(51) Int. Cl. G01S 17/14; G01S 7/4913; G01S 17/89

(52) U.S. Cl. CPC G01S 17/14; G01S 7/4913; G01S 17/89

(57) ABSTRACT

The present invention includes a light source unit; a light receiving pixel unit which includes a photo electric conversion device and an electric charge accumulating unit, and a distance image processing unit, when the distance is measured by an input voltage in accordance with an electric charge accumulated in the electric charge accumulating unit, that: measures a distance via a normal mode at a predetermined width of radiation light when the distance is measured by an input voltage in accordance with an electric charge accumulated in the electric charge accumulating unit, and switches to the detailed measurement mode according to the distance to the object measured via the normal mode and adjusts a phase of the radiation light radiated from the light source unit by a detailed measurement mode.

### TECHNICAL FIELD

The present invention relates to a distance image capturing device and a distance image capturing method.

### BACKGROUND ART

Conventionally, distance image sensors of a time of flight (hereinafter, referred to as “TOF”) system measuring the distance between a measurement unit and an object on the basis of a flying time of light in a space (measurement space) using the fact that the speed of light is known have been realized. In a distance image sensor of a TOF system, a light (for example, near infrared light or the like) pulse is emitted to a measurement target, and the distance between a measurement unit and an object is measured on the basis of a difference between a time at which the light pulse is emitted and a time at which the light pulse (reflected light) is reflected on the object and returns in the measurement space, in other words, a flight time of the light between the measurement unit and the object (for example, see Patent Document 1).

The distance image sensor of this TOF system can set a measurable distance range using a width of the light pulse. For this reason, a distance image sensor of the TOF system can measure a distance in a wider distance range in accordance with widening of the width of the light pulse.

A distance image sensor of a TOF system sets and uses the light pulse width in accordance with a distance measurement range required for the purpose of use.

In addition, by setting a period in which light is not constantly emitted for canceling out the influence of background light in the environment of the measurement space, the light reception amount of only the background light is accumulated, and components according to the background light are subtracted from a signal including information of a delay of reflected light, whereby the influence of the background light is eliminated.

### CITATION LIST

### Patent Literature

[Patent Document 1]

Japanese Unexamined Patent Application, First Publication No. 2004-294420

### SUMMARY OF INVENTION

### Technical Problem

As described above, according to Patent Document 1, the distance between an object and a distance image sensor is measured in a measurement range corresponding to the width of the light pulse defined in the measurement space. This measurement range represents a range in which the distance from the distance image sensor is from a minimum distance (short distance) at which reflected light from the object can be measured after emission of a light pulse to a maximum distance (long distance) at which the reflected light can be measured with the pulse width, for example, a distance range from a minimum distance of 0.1 m from the distance image sensor to a maximum distance of 4 m.

However, for measuring a wide distance range, the accuracy of measurement (distance resolution) in an area at each of a short distance and a long distance cannot be optimized in accordance with the area of each of a short distance and a long distance.

In view of the problems described above, an object is to provide a distance image capturing device and a distance image capturing method in which accuracy of measurement of distances (distance resolution) is capable of being improved in an area of each of a short distance and a long distance in a range from a minimum distance (short distance) at which reflected light reflected from an object can be measured after emission of a light pulse to a maximum distance (long distance) at which reflected light can be measured with a pulse width.

### Solution to Problem

A distance image capturing device according to the present invention includes: a light source unit which radiates radiation light into a measurement space that is a space to be measured; a light receiving pixel unit which includes: a photo electric conversion device that receives reflected light which the radiation light has been reflected from an object in the measurement space and background light in an environment of the measurement space, and that generates an electric charge in accordance with the received reflected light and the background light; and an electric charge accumulating unit which accumulates the electric charge when the radiation light is irradiated in a frame period; and the light receiving pixel unit including a pixel circuit that accumulates the electric charge in the electric charge accumulating unit in synchronization with irradiation of the radiation light, and a distance image processing unit, when the distance is measured by an input voltage in accordance with an electric charge accumulated in the electric charge accumulating unit, that measures a distance via a normal mode at a predetermined width of radiation light, switches to the detailed measurement mode according to the distance to the object measured via the normal mode and adjusts a phase of the radiation light radiated from the light source unit by a detailed measurement mode.

In the distance image capturing device according to the present invention, the distance image processing unit may measure a distance via the normal mode at a predetermined width of radiation light and adjust a width together with the phase of the radiation light emitted from the light source unit in the detailed measurement mode in correspondence with the distance to the object.

In the distance image capturing device according to the present invention, a distance range that is a range of a distance that is capable of being measured in the normal mode may be divided into a plurality of sub-measurement ranges having the same width in the detailed measurement mode, the width of the radiation light may be set in correspondence with a corresponding sub-measurement range, and the phase of the radiation light may be set in correspondence with a minimum distance in the sub-measurement range.

In the distance image capturing device according to the present invention, after measuring the distance via the normal mode, the distance image processing unit may perform distance measurement via the detailed measurement mode that uses the width and the phase of radiation light set in correspondence with the sub-measurement range in which the distance acquired in the measurement is included.

In the distance image capturing device according to the present invention, the distance image processing unit acquires the distance to the object present in the measurement space on the basis of an electric charge that is the electric charge distributed for a fixed number of times of distribution of electric charge set in advance in the normal mode and accumulated in each of a plurality of distributed electric charge accumulating units of the electric charge accumulating unit and, after measuring the distance in the normal mode, performs distance measurement via the detailed measurement mode on the basis of the electric charge for the number of times of distribution of electric charge set in correspondence with the sub-measurement range in which the distance acquired in the measurement is included.

In the distance image capturing device according to the present invention, the distance image processing unit adjusts an intensity of the radiation light emitted from the light source unit in correspondence with the distance to the object.

In the distance image capturing device according to the present invention, in a case in which the distance to the object is acquired on the basis of the ratio between electric charges that are electric charges accumulated in a first distributed electric charge accumulating unit and a second distributed electric charge accumulating unit that are two electric charge accumulating units accumulating electric charge of the reflected light, the distance image processing unit, after switching to the detailed measurement mode, switches to the normal mode without performing a process of acquiring a distance in a case in which the electric charge according to the reflected light in one of the first distributed electric charge accumulating unit and the second distributed electric charge accumulating unit is equal to or smaller than an electric charge threshold set in advance.

In the distance image capturing device according to the present invention, the electric charge threshold is an electric charge accumulated in a background light electric charge accumulating unit in accordance with background light.

In the distance image capturing device according to the present invention, in a case in which the distance to the object is acquired on the basis of the ratio between electric charges that are electric charges accumulated in a first distributed electric charge accumulating unit and a second distributed electric charge accumulating unit that are two electric charge accumulating units accumulating electric charge of the reflected light, the distance image processing unit, after measuring a distance via the normal mode, adjusts the phase of the radiation light such that electric charges of the first distributed electric charge accumulating unit and the second distributed electric charge accumulating unit are the same and acquires the distance on the basis of the electric charges and the amount of adjustment of the phase.

In the distance image capturing device according to the present invention, after the adjustment of the phase of the radiation light is performed and the electric charges are the same, the distance image processing unit adjusts widths of accumulation drive signals for distributing electric charge to the first distributed electric charge accumulating unit and the second distributed electric charge accumulating unit such that there is no area in which electric charge according to the reflected light is not included.

A distance image capturing method according the present invention includes: a process of emitting radiation light to a measurement space that is a space of a measurement target; a process of receiving reflected light acquired by reflecting the radiation light on an object in the measurement space and background light in an environment of the measurement space and generating electric charge according to the reflected light and the background light that have been received using a photo electric conversion device; a process of accumulating the electric charge according to the reflected light in an electric charge accumulating unit in synchronization with emission of the radiation light in a frame period; a process of measuring a distance using a normal mode at a predetermined width of radiation light at the time of performing distance measurement using an input voltage according to an electric charge accumulated in the electric charge accumulating unit; and a process of switching to a detailed measurement mode and adjusting the phase of the radiation light emitted from the light source unit in correspondence with the distance to the object measured via the normal mode.

### Advantageous Effects of Invention

The present invention provides a distance image capturing device and a distance image capturing method improving accuracy of measurement of distances (distance resolution) in an area of each of a short distance and a long distance in a range from a minimum distance (short distance) at which reflected light reflected from an object can be measured after emission of a light pulse to a maximum distance (long distance) at which reflected light can be measured with a pulse width.

### BRIEF DESCRIPTION OF DRAWINGS

FIG. 1 is a block diagram illustrating a schematic configuration of a distance image capturing device according to a first embodiment of the present invention.

FIG. 2 is a block diagram illustrating a schematic configuration example of a distance image sensor used in a distance image capturing device 1 according to an embodiment of the present invention.

FIG. 3 is a circuit diagram illustrating an example of the configuration of a pixel circuit 321 disposed inside a light receiving pixel unit 320 of an imaging device (a distance image sensor 32) used in the distance image capturing device 1 according to the embodiment of the present invention.

FIG. 4 is a timing diagram illustrating timings at which the pixel circuit 321 disposed inside the light receiving pixel unit 320 of the imaging device (the distance image sensor 32) used in the distance image capturing device 1 according to the embodiment of the present invention is driven.

FIG. 5 is a conceptual diagram illustrating an example configuration of an AD conversion circuit that performs AD conversion of an input voltage supplied from a pixel signal processing circuit according to an embodiment of the present invention.

FIG. 6 is a block diagram illustrating an example configuration of a distance calculating unit 42 of a distance image processing unit 4 according to the first embodiment.

FIG. 7 is a timing diagram illustrating a phase of a light pulse PO in each of a normal mode, a short-distance mode, and a long-distance mode in an electric charge accumulation period according to the first embodiment.

FIG. 8 is a flowchart illustrating an operation example of a distance measurement process using the distance image capturing device 1 according to the first embodiment.

FIG. 9 is a diagram illustrating effects of distance measurement using a detailed measurement mode according to the distance image capturing device 1 according to this embodiment.

FIG. 10 is a timing diagram illustrating a phase of a light pulse PO in each of a normal mode, a short-distance mode, and a long-distance mode in an electric charge accumulation period in another configuration according to this embodiment.

FIG. 11 is a block diagram illustrating an example configuration of a distance calculating unit 42A of a distance image processing unit 4 according to a second embodiment.

FIG. 12 is a diagram illustrating adjustment of a phase for emitting a light pulse PO that is performed by a change amount adjusting unit 428 according to the second embodiment.

FIG. 13 is a flowchart illustrating an operation example of the process of adjusting the phase of the light pulse PO that is performed by a distance image capturing device 1 according to the second embodiment.

FIG. 14 is a block diagram illustrating an example configuration of a distance calculating unit 42B of a distance image processing unit 4 according to a third embodiment.

FIG. 15 is a diagram illustrating adjustment of pulse widths of accumulation drive signals TX1, TX2, and TX3 according to the third embodiment.

FIG. 16 is a flowchart illustrating an operation example of an adjustment process of pulse widths of the accumulation drive signals TX1, TX2, and TX3 that is performed by a distance image capturing device 1 according to the third embodiment.

### DESCRIPTION OF EMBODIMENTS

### First Embodiment

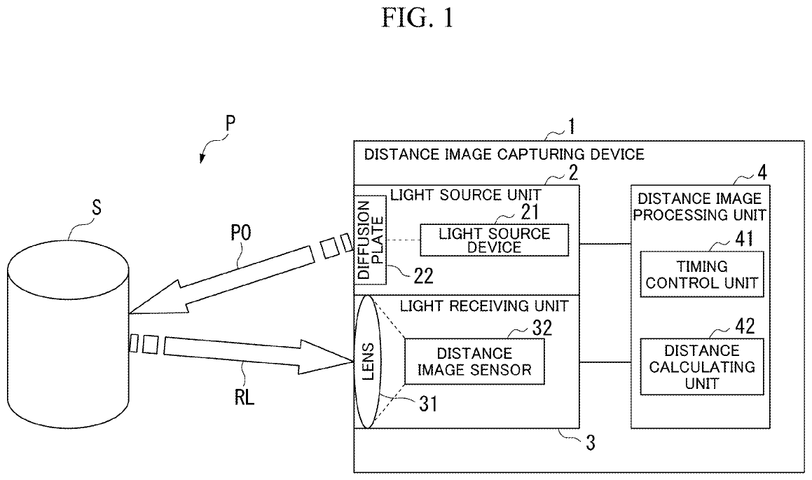

Hereinafter, a first embodiment of the present invention will be described with reference to the drawings. FIG. 1 is a block diagram illustrating a schematic configuration of a distance image capturing device according to this embodiment. In addition, a subject S that is a subject for which a distance is measured by the distance image capturing device 1 is also illustrated in FIG. 1.

The distance image capturing device 1 having the configuration illustrated in FIG. 1 includes a light source unit 2, a light receiving unit 3, and a distance image processing unit 4.

The light source unit 2 emits an intermittent light pulse PO to a space at predetermined intervals in accordance with control from the distance image processing unit 4. The subject S that is a target, for which a distance is measured by the distance image capturing device 1, is present in the space. The light source unit 2, for example, is a semiconductor laser module of a surface emission type such as a vertical cavity surface emitting laser (VCSEL).

The light source device 21, for example, is a light source that emits laser light having a near infrared wavelength band (for example, the wavelength is in a wavelength band of 850 nm to 940 nm) that becomes a light pulse PO emitted to a subject S. The light source device 21, for example, is a semiconductor laser light emitting device. The light source device 21 emits laser light (a light pulse PO) having a pulse shape in accordance with control from the timing control unit 41.

The diffusion plate 22 is an optical component that diffuses laser light of a near infrared wavelength band emitted by the light source device 21 in a size of a predetermined cross-section by emitting the laser light into a measurement space P in which a subject S is present. Pulse-shaped laser light diffused by the diffusion plate 22 exits from the light source unit 2 as a light pulse PO and is emitted to a subject S in the measurement space P.

The light receiving unit 3 receives reflected light RL of a light pulse PO reflected from a subject S that is a target for which a distance is measured by the distance image capturing device 1 and outputs a pixel signal according to the received reflected light RL.

The lens 31 is an optical lens leading incident reflected light RL to the distance image sensor 32. The lens 31 causes the incident reflected light RL to exit to the distance image sensor 32 side and be received by (incident to) pixels provided in a light reception area of the distance image sensor 32.

The distance image sensor 32 is an imaging device used in the distance image capturing device 1. The distance image sensor 32 is an imaging device that includes a plurality of pixels in a two-dimensional light reception area and has a distribution configuration in which one photo electric conversion device, a plurality of electric charge accumulating units corresponding to one photo electric conversion device, and a constituent element distributing electric charge to the electric charge accumulating units are disposed in each of the pixels. The distance image sensor 32 distributes electric charge generated by a photo electric conversion device configuring a pixel to the electric charge accumulating units and outputs a pixel signal corresponding to the electric charge distributed to each electric charge accumulating unit in accordance with control from the timing control unit 41.

In addition, a plurality of pixels are disposed in a two-dimensional lattice pattern (matrix pattern) in the distance image sensor 32, and pixel signals corresponding to one frame corresponding to each pixel are output.

The distance image processing unit 4 is a control unit that controls the entire distance image capturing device 1 and is also an arithmetic calculation unit that calculates the distance to a subject S to be measured by the distance image capturing device 1. This distance image processing unit 4 includes a timing control unit 41 and a distance calculating unit 42.

The timing control unit 41 controls a timing at which the light source unit 2 emits a light pulse PO to a subject S, a timing at which the distance image sensor 32 included in the light receiving unit 3 receives reflected light RL, and the like.

The distance calculating unit 42 outputs distance information acquired by calculating the distance between the distance image capturing device 1 and a subject S on the basis of a pixel signal output from the distance image sensor 32.

By employing such a configuration, in the distance image capturing device 1, reflected light RL acquired by causing a light pulse PO of a near infrared wavelength band, which is emitted by the light source unit 2 to the subject S, to be reflected on the subject S is received by the light receiving unit 3, and the distance image processing unit 4 outputs distance information acquired by measuring the distance from the subject S.

In addition, although the distance image capturing device 1 having a configuration in which the distance image processing unit 4 is provided on the inside thereof is illustrated in FIG. 1, the distance image processing unit 4 may be a constituent element provided outside the distance image capturing device 1.

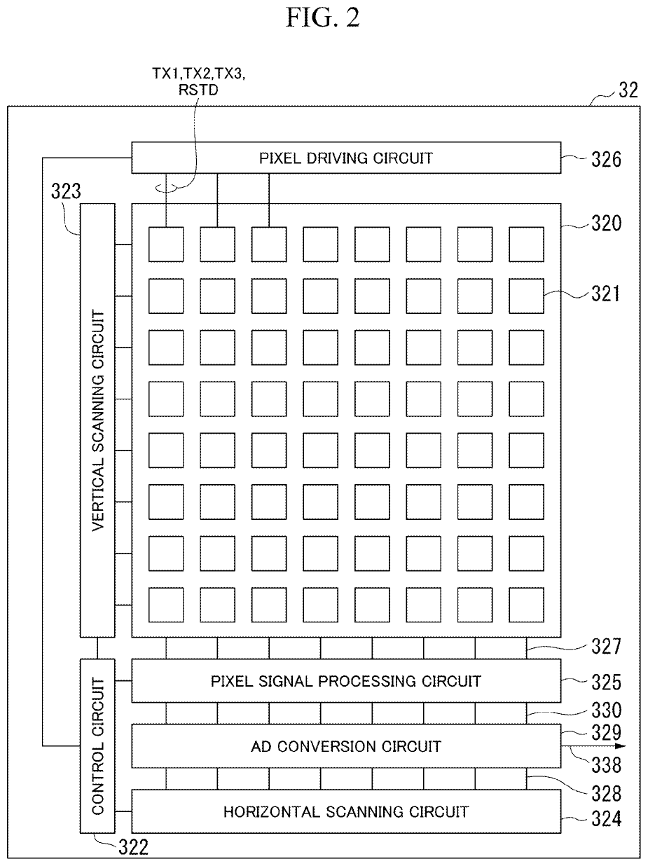

Next, the configuration of the distance image sensor 32 used as an imaging device in the distance image capturing device 1 will be described. FIG. 2 is a block diagram illustrating a schematic configuration of the imaging device (the distance image sensor 32) used in the distance image capturing device 1 according to an embodiment of the present invention. As shown in FIG. 2, the distance image sensor 32 includes a light receiving pixel unit 320 in which a plurality of pixel circuits 321 are disposed, a control circuit 322, a vertical scanning circuit 323, a horizontal scanning circuit 324, a pixel signal processing circuit 325, and a pixel driving circuit 326. In addition, in the distance image sensor 32 shown in FIG. 2, an example of the light receiving pixel unit 320 in which the plurality of pixel circuits 321 are disposed in a two-dimensional lattice pattern of eight rows and eight columns is shown.

The control circuit 322 controls constituent elements such as the vertical scanning circuit 323, the horizontal scanning circuit 324, the pixel signal processing circuit 325, the pixel driving circuit 326, and the like included in the distance image sensor 32. The control circuit 322, for example, controls operations of the constituent elements included in the distance image sensor 32 in accordance with control from the distance image processing unit 4 (more specifically, the timing control unit 41) included in the distance image capturing device 1. In addition, control of the constituent elements included in the distance image sensor 32 using the control circuit 322, for example, may be configured to be directly performed by the distance image processing unit 4 (more specifically, the timing control unit 41). In such a case, the distance image sensor 32 may be configured not to include the control circuit 322.

The pixel driving circuit 326 outputs accumulation drive signals (accumulation drive signals TX1, TX2, and TX3 and a reset drive signal RSTD to be described below) for distributing electric charge generated by photo electric conversion devices (photo electric conversion devices PD to be described below) included in the pixel circuits 321 arranged in a lattice pattern to a plurality of electric charge accumulating units (electric charge accumulating units CS1, CS2, and CS3 to be described below) included in the pixel circuits 321 and accumulating the generated electric charges in the pixel circuits 321 disposed in a lattice pattern inside the light receiving pixel unit 320 in units of columns.

The vertical scanning circuit 323 is a drive circuit that outputs a signal of a voltage (hereinafter, referred to as a “voltage signal”) corresponding to an electric charge acquired by performing photo electric conversion of light incident from each of the pixel circuits 321 to a corresponding vertical signal line 327 (causes the voltage signal to be read) by controlling each of the pixel circuits 321 disposed inside the light receiving pixel unit 320 in accordance with control from the control circuit 322. The vertical scanning circuit 323 outputs control signals (selection drive signals SEL1, SEL2, and SEL3 to be described below) for reading data by driving (controlling) the pixel circuits 321 to the pixel circuits 321 disposed in a lattice pattern inside the light receiving pixel unit 320 in units of rows.

In accordance with this, a voltage signal corresponding to an electric charge distributed to each electric charge accumulating unit in the pixel circuit 321 is read into a corresponding vertical signal line 327 for each row of the light receiving pixel unit 320 and is output to the pixel signal processing circuit 325.

In the light receiving pixel unit 320, the pixel circuit 321 receives reflected light RL acquired by reflecting a light pulse PO, which has been emitted by the light source unit 2 onto the subject S, on the subject S and generates electric charge corresponding to the amount of light (a light reception amount) of the received reflected light RL. In each pixel circuit 321, by outputting an accumulation drive signal, the pixel driving circuit 326 distributes electric charge corresponding to the light amount (light reception amount) of the received reflected light RL to one of a plurality of electric charge accumulating units and accumulates the electric charge in the corresponding electric charge accumulating unit. Then, in the pixel circuit 321, by outputting a read drive signal, the vertical scanning circuit 323 outputs a voltage signal of a magnitude corresponding to the electric charge of electric charge that is distributed to each electric charge accumulating unit and is accumulated in the electric charge accumulating units to a corresponding vertical signal line 327. A detailed description of the configuration and a drive (control) method of the pixel circuit 321 will be described below.

The pixel signal processing circuit 325 is a signal processing circuit that performs signal processing set in advance on a voltage signal output from the pixel circuit 321 of each column to the corresponding vertical signal line 327 in accordance with control from the vertical scanning circuit 323. As examples of the signal processing set in advance, there are a noise suppression process of suppressing noise included in a voltage signal through (correlated double sampling CDS) and the like.

An AD conversion circuit 329 converts an analog voltage signal for each column supplied from the pixel signal processing circuit 325 through the vertical signal line 330 into a digital value through AD conversion.

In addition, the pixel signal processing circuit 325 may be a pixel signal processing circuit group configured by a plurality of pixel signal processing circuits corresponding to the columns of the light receiving pixel unit 320. In such a case, the pixel signal processing circuit 325 outputs a voltage signal after the signal processing set in advance to the AD conversion circuit 329 through the vertical signal line 330 in accordance with control from the control circuit 322.

Then, the AD conversion circuit 329 outputs a resultant signal to the horizontal signal line 338 for each row of the light receiving pixel unit 320 in accordance with control of the horizontal scanning circuit 324.

The horizontal scanning circuit 324 is a drive circuit that sequentially outputs digital values acquired by performing AD conversion of voltage signals after signal processing output from the AD conversion circuit 329 through the signal lines 328 to (causes the digital values to be read into) the horizontal signal line 338 in accordance with control from the control circuit 322. The horizontal scanning circuit 324 sequentially outputs read drive signals used for outputting voltage signals corresponding to the pixel circuit 321 of columns to the pixel signal processing circuit 325. In accordance with this, voltage signals corresponding to one frame after signal processing output by the pixel signal processing circuit 325 are sequentially output to the outside of the distance image sensor 32 through the horizontal signal line 338 as pixel signals corresponding to one frame. At this time, the distance image sensor 32, for example, outputs a voltage signal after signal processing from an output circuit such as an output amplifier not shown in the drawing to the outside of the distance image sensor 32 as a pixel signal.

In the following description, the pixel signal processing circuit 325 included in the distance image sensor 32 will be described as performing a noise suppression process for a voltage signal output from the pixel circuit 321, thereafter performs an A/D conversion process, and outputs a resultant signal to the AD conversion circuit 329, in other words, outputs a voltage signal converted into a digital value from the horizontal signal line 338.

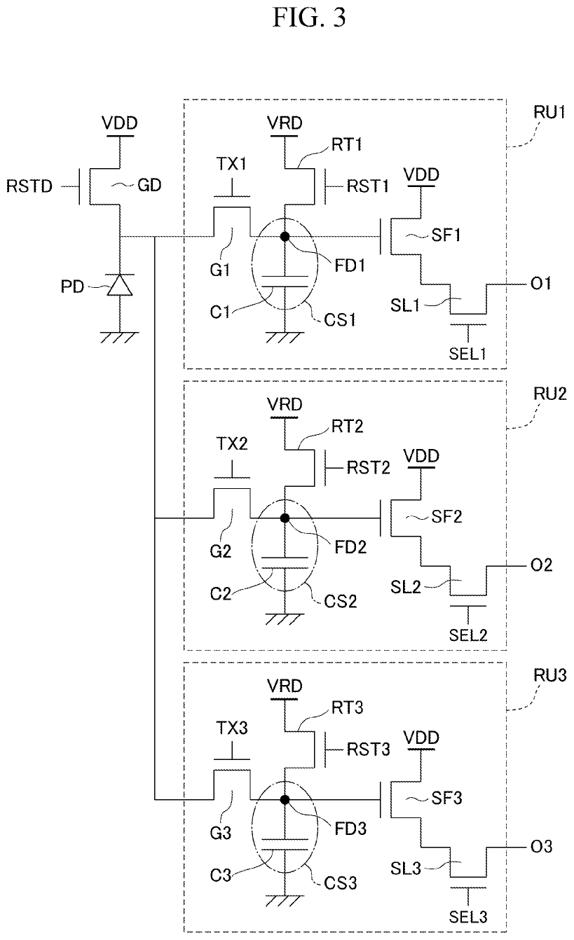

Next, the configuration of the pixel circuit 321 disposed within the light receiving pixel unit 320 included in the distance image sensor 32 will be described. FIG. 3 is a circuit diagram illustrating one example of the configuration of the pixel circuit 321 disposed within the light receiving pixel unit 320 of an imaging device (the distance image sensor 32) used in the distance image capturing device 1 according to an embodiment of the present invention. FIG. 3 illustrates one example of the configuration of one pixel circuit 321 among a plurality of pixel circuits 321 disposed within the light receiving pixel unit 320. The pixel circuit 321 is one example of a configuration including three pixel signal reading units.

The pixel circuit 321 includes one photo electric conversion device PD, a drain gate transistor GD, and three pixel signal reading units RU that output voltage signals from corresponding output terminals O. Each of the pixel signal reading units RU includes a reading gate transistor G, a floating diffusion FD, an electric charge accumulating capacitor C, a reset gate transistor RT, a source follower gate transistor SF, and a selection gate transistor SL. In each of the pixel signal reading units RU, an electric charge accumulating unit CS is composed of the floating diffusion FD and the electric charge accumulating capacitor C. The drain gate transistor GD, the reading gate transistor G, the reset gate transistor RT, the source follower gate transistor SF, and the selection gate transistor SL are N-channel MOS transistors.

In addition, in FIG. 3, by assigning numbers “1”, “2”, and “3” to after reference signs “RU” of three pixel signal reading units RU, the individual pixel signal reading units RU can be distinguished from each other. In addition, similarly, also for each constituent element included in any one of the three pixel signal reading units RU, by indicating with a number representing the pixel signal reading unit RU after a reference sign, the pixel signal reading unit RU to which each constituent element corresponds can be represented in a distinguishing manner. In the pixel circuit 321 shown in FIG. 3, the pixel signal reading unit RU1 that outputs a voltage signal from an output terminal O1 includes a reading gate transistor G1, a floating diffusion FD1, an electric charge accumulating capacitor C1, a reset gate transistor RT1, a source follower gate transistor SF1, and a selection gate transistor SL1. In the pixel signal reading unit RU1, an electric charge accumulating unit CS1 is composed of a floating diffusion FD1 and an electric charge accumulating capacitor C1. The pixel signal reading unit RU2 and the pixel signal reading unit RU3 have configurations similar thereto.

The photo electric conversion device PD is a photodiode of an embedded type that generates electric charge by performing a photo electric conversion of incident light and accumulates the generated electric charge. In addition, the structure of the photo electric conversion device PD included in the pixel circuit 321 is not particularly defined in the present invention. For this reason, the photo electric conversion device PD, for example, may be either a PN photo diode having a structure in which a P-type semiconductor and an N-type semiconductor are bonded or a PIN photodiode having a structure in which an I-type semiconductor is interposed between a P-type semiconductor and an N-type semiconductor. In addition, the photo electric conversion device included in the pixel circuit 321 is not limited to a photodiode and, for example, may be a photo electric conversion device of a photo-gate type.

The drain gate transistor GD is a transistor for discarding electric charge that is generated and accumulated by the photo electric conversion device PD in accordance with a drive signal input from the pixel driving circuit 326 and is not transmitted to each pixel signal reading unit RU. In other words, the drain gate transistor GD is a transistor that resets electric charge that is generated by the photo electric conversion device PD and is not used for measuring the distance to a subject S.

The reading gate transistor G is a transistor that is used for transmitting electric charge generated and accumulated by the photo electric conversion device PD in accordance with a drive signal input from the pixel driving circuit 326 to a corresponding electric charge accumulating unit CS. The electric charge transmitted by the reading gate transistor G is stored (accumulated) in a corresponding electric charge accumulating unit CS.

Here, in the pixel signal reading unit RU1, the reading gate transistor G1 has a drain connected to a second terminal of the photo electric conversion device PD, a gate connected to a signal line LTX1 through which an accumulation drive signal TX1 propagates, and a source connected to the floating diffusion FD1 and a first terminal of the electric charge accumulating capacitor C1.

Similarly, in the pixel signal reading unit RU2, the reading gate transistor G2 has a drain connected to the second terminal of the photo electric conversion device PD, a gate connected to a signal line LTX2 through which an accumulation drive signal TX2 propagates, and a source connected to the floating diffusion FD2 and a first terminal of the electric charge accumulating capacitor C2.

In addition, similarly, in the pixel signal reading unit RU3, the reading gate transistor G3 has a drain connected to the third terminal of the photo electric conversion device PD, a gate connected to a signal line LTX3 through which an accumulation drive signal TX3 propagates, and a source connected to the floating diffusion FD3 and a first terminal of the electric charge accumulating capacitor C3.

The accumulation drive signal TX1, the accumulation drive signal TX2, and the accumulation drive signal TX3 described above are supplied from the pixel driving circuit 326 respectively through the signal line LTX1, the signal line LTX2, and the signal line LTX3.

The electric charge accumulating capacitor C is a capacitor that stores (accumulates) electric charge transmitted by a corresponding reading gate transistor G.

The reset gate transistor RT is a transistor used for distributing electric charge stored in a corresponding electric charge accumulating unit CS in accordance with a drive signal input from the vertical scanning circuit 323. In other words, the reset gate transistor RT is a transistor that resets electric charge stored in a corresponding electric charge accumulating unit CS.

The source follower gate transistor SF is a transistor that is used for amplifying a voltage signal corresponding to the electric charge accumulated in the electric charge accumulating unit CS connected to the gate terminal and outputting the amplified voltage signal to a corresponding selection gate transistor SL.

The selection gate transistor SL is a transistor used for outputting a voltage signal amplified by the corresponding source follower gate transistor SF in accordance with a drive signal input from the vertical scanning circuit 323 from the corresponding output terminal O.

By employing the configuration described above, the pixel circuit 321 distributes the electric charge generated by performing a photo electric conversion of incident light using the photo electric conversion device PD to the three electric charge accumulating units CS and outputs voltage signals corresponding to the amounts of distributed electric charge to the pixel signal processing circuit 325.

The configuration of the pixel disposed in the distance image sensor 32 is not limited to the configuration including the three pixel signal reading units RU as shown in FIG. 3, and the pixel may have any configuration as long as the pixel has a configuration including one photo electric conversion device PD and a plurality of pixel signal reading units RU distributing electric charge generated and accumulated by the photo electric conversion device PD. In other words, the number of pixel signal reading units RU (electric charge accumulating units CS) included in the pixel disposed in the distance image sensor 32 may be two or four or more.

In addition, in the pixel circuit 321 shown in FIG. 3, one example in which the electric charge accumulating unit CS is composed of the floating diffusion FD and the electric charge accumulating capacitor C is shown. However, the electric charge accumulating unit CS may be composed of at least the floating diffusion FD. In other words, the pixel circuit 321 may have a configuration not including each electric charge accumulating capacitor C. In the case of such a configuration, there is an advantage of improving electric charge detection sensitivity. However, in the distance image capturing device 1, in consideration of widening a dynamic range in the measurement of a distance, a configuration capable of storing (accumulating) more electric charge is superior. For this reason, in the pixel circuit 321, by including the electric charge accumulating capacitor C in the pixel signal reading unit RU and configuring the electric charge accumulating unit CS using the floating diffusion FD and the electric charge accumulating capacitor C, a configuration capable of storing (accumulating) more electric charge than in a case in which the electric charge accumulating unit CS is configured using only the floating diffusion FD is employed.

In addition, in the pixel circuit 321 having the configuration shown in FIG. 3, although one example of the configuration including the drain gate transistor GD is shown, a configuration in which no drain gate transistor GD is included in the pixel disposed in the distance image sensor 32 may be employed in a case in which electric charge accumulated (remaining) in the photo electric conversion device PD does not need to be discarded.

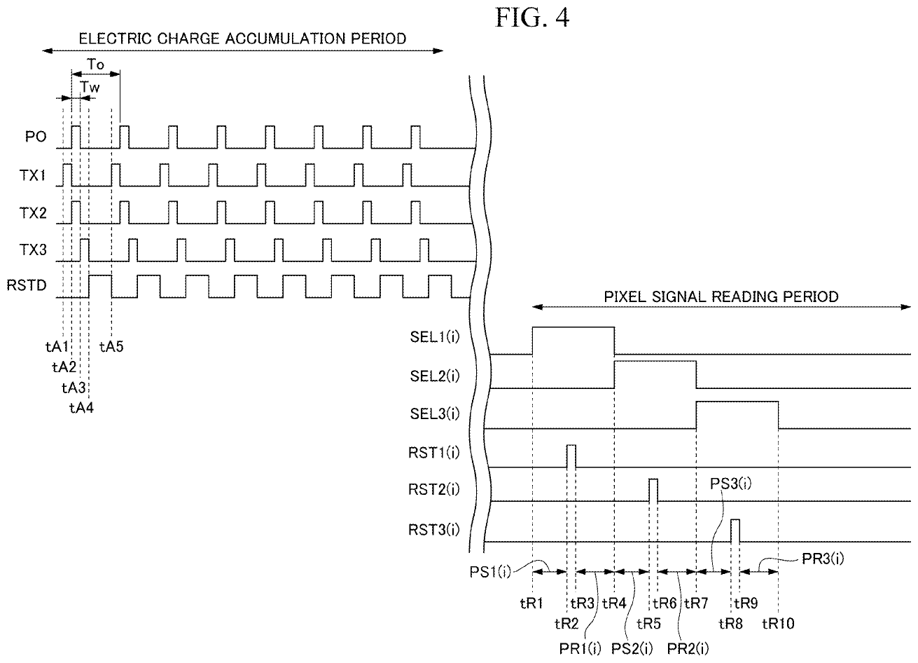

Next, a method (timings) of driving (controlling) the pixel circuit 321 in the distance image capturing device 1 will be described. FIG. 4 is a timing diagram illustrating timings at which a pixel circuit 321 disposed within the light receiving pixel unit 320 of an imaging device (the distance image sensor 32) used in the distance image capturing device 1 according to an embodiment of the present invention is driven. FIG. 4 illustrates timings of a light pulse PO emitted by the light source unit 2 to a subject S together with timings of a drive signal of the pixel circuit 321 when pixel signals corresponding to one frame are output to the distance image sensor 32.

First, driving (controlling) the pixel circuit 321 in an electric charge accumulation period in which electric charge generated and accumulated by the photo electric conversion device PD corresponding to an amount (light reception amount) of received light is distributed to each pixel signal reading unit RU will be described. In the electric charge accumulation period, a light pulse PO is emitted to a subject S by the light source unit 2. Then, by driving pixel circuits 321 in synchronization with timings at which a light pulse PO is emitted, electric charge corresponding to background light and reflected light RL that have been received is distributed to respective electric charge accumulating units CS. The pixel driving circuit 326 distributes and accumulates electric charge into respective electric charge accumulating unit CS included in all the pixel circuits 321 through so-called global shutter driving in which all the pixel circuits 321 disposed within the light receiving pixel unit 320 are simultaneously driven. In addition, a time in which the light source device 21 emits pulse-shaped laser light, in other words, a pulse width Tw of the light pulse PO, for example, is a very short time set in advance such as 10 ns or the like. The reason for this is that the maximum distance that can be measured (hereinafter, referred to as a “maximum measurement distance”) is determined in accordance with the pulse width Tw of the light pulse PO in the measurement of a distance using a pulse modulation system. In a case in which the pulse width Tw of the light pulse PO described above is 10 ns, the maximum measurement distance becomes 1.5 m. In addition, by widening the pulse width Tw of the light pulse PO, in other words, by increasing an emission time of laser light in the light source device 21, although the photo electric conversion device PD can receive more reflected light RL, the resolution of the distance from the subject S that is to be measured decreases. On the other hand, by shortening the pulse width Tw of the light pulse PO, the electric charge generated through a photo electric conversion by the photo electric conversion device PD decreases. For this reason, emission of a light pulse PO and distribution of electric charge are performed a plurality of number of times such that a sufficient electric charge is accumulated in each electric charge accumulating unit CS in an electric charge accumulation period in the distance image capturing device 1.

Here, each of the vertical scanning circuit 323 and the pixel driving circuit 326 will be described as being configured to drive (control) the pixel circuits 321. In the following description, the control circuit 322 outputs clock signals CK1, CK2, CK3, and CKRSTD for respectively generating the accumulation drive signals TX1, TX2, and TX3, and the reset drive signal RSTD to the pixel driving circuit 326. In addition, the control circuit 322 outputs clock signals for respectively generating the selection drive signals SEL1, SEL2, and SEL3 and the reset signal RST1, RST2, and RST3 to the vertical scanning circuit 323.

In the electric charge accumulation period of the timing diagram shown in FIG. 4, driving timings of pixel circuits 321 in a case in which emission of a light pulse PO and distribution of electric charge are performed a plurality of number of times in all the pixel circuits 321 are shown. In addition, a light pulse PO in the electric charge accumulation period of the timing diagram shown in FIG. 4 will be described such that the light pulse PO is emitted (laser light is emitted by the light source device 21) at the time of a “H (High)” level, and the emission of the light pulse PO stops (the light source device 21 is turned off) at the time of an “L (Low)” level. In addition, the timing diagram shown in FIG. 4 will be described as being started from a state in which all the pixel circuits 321 are reset, in other words, no electric charge is accumulated in the photo electric conversion devices PD and the electric charge accumulating units CS.

In the following description, a period of a time tA1 to a time tA5 is an accumulation period in which electric charge is distributed, and a plurality of accumulation periods are repeated in the electric charge accumulation period. For example, time widths between times tA1, tA2, tA3, and tA4, that is, pulse widths of the light pulse PO and the accumulation drive signals TX1, TX2, and TX3 are the same Tw.

In the electric charge accumulation period, first, the pixel driving circuit 326 transmits electric charge corresponding to background light before emission of the light pulse PO, which has been generated through a photo electric conversion by the photo electric conversion device PD, to the electric charge accumulating unit CS1 through the reading gate transistor G1 and accumulates the electric charge therein from a time tA1 that is a time before the same time as the pulse width Tw in which the light source unit 2 emits the light pulse PO.

Thereafter, the pixel driving circuit 326 transmits electric charge generated by the photo electric conversion device PD in accordance with light that is currently being photoelectrically converted by the photo electric conversion device PD to the electric charge accumulating unit CS2 through the reading gate transistor G2 and accumulates the electric charge therein from the same time tA2 as a timing at which the light source unit 2 emits the light pulse PO. Here, the electric charge accumulated in the electric charge accumulating unit CS2 is electric charge corresponding to reflected light RL reflected on the subject S within the time of the pulse width Tw in which the light pulse PO is emitted. In this electric charge, in addition to the electric charge corresponding to the background light, electric charge corresponding to reflected light RL incident in a delay time that decreases in proportion to the distance (absolute distance) to a subject S is included. More specifically, for example, in a case in which a subject S is present at a close position, the emitted light pulse PO is reflected on the subject S in a short time and is returned as reflected light RL, and accordingly, more electric charge corresponding to the reflected light RL reflected on the subject S that is present at the close position is included in the electric charge accumulating unit CS2.

Thereafter, the pixel driving circuit 326 transmits electric charge generated by the photo electric conversion device PD in accordance with light that is currently photoelectrically converted by the photo electric conversion device PD to the electric charge accumulating unit CS3 through the reading gate transistor G3 and accumulates the electric charge therein from the same time tA3 as a timing at which the light source unit 2 stops emission of the light pulse PO. Here, the electric charge accumulated in the electric charge accumulating unit CS3 is electric charge corresponding to reflected light RL reflected on the subject S other than at the time of the pulse width Tw in which the light pulse PO is emitted. In this electric charge, in addition to the electric charge corresponding to the background light, electric charge corresponding to reflected light RL incident in a delay time that increases in proportion to the distance (absolute distance) to a subject S is included. More specifically, for example, in a case in which a subject S is present at a distant position, the emitted light pulse PO is reflected from the subject S and returned as reflected light RL requiring a longer time, and accordingly, more electric charge corresponding to the reflected light RL reflected from the subject S that is present at the distant position is included in the electric charge accumulating unit CS3.

Thereafter, the pixel driving circuit 326 discards electric charge that has been generated in accordance with light currently photoelectrical-converted by the photo electric conversion device PD, in other words, electric charge not used for measurement of the distance to the subject S through the drain gate transistor GD from a time tA4 when the same time as the pulse width Tw in which the light source unit 2 emits the light pulse PO elapses. In other words, the photo electric conversion device PD is reset.

Thereafter, the pixel driving circuit 326 releases the resetting of the photo electric conversion device PD at a time tA5 that is a time before the same time as the pulse width Tw in which the light source unit 2 emits a light pulse PO next time. Then, similar to the timing from the time tA1, the pixel driving circuit 326 transmits electric charge generated through a photo electric conversion next time by the photo electric conversion device PD, in other words, electric charge corresponding to background light before emission of a light pulse PO next time to the electric charge accumulating unit CS1 through the reading gate transistor G1 and accumulates the electric charge therein.

Thereafter, the pixel driving circuit 326 repeats driving of pixel circuits 321 similar to that from the time tA1 to the time tA5 (hereinafter, referred to as “electric charge distribution driving”). In this way, in the electric charge accumulation period, electric charges corresponding to the repetition of electric charge distribution driving are accumulated and stored in the electric charge accumulating units CS included in all the pixel circuits 321. In addition, the maximum number of times at which the electric charge distribution driving is repeated in the electric charge accumulation period is determined in accordance with a period at which the distance image sensor 32 outputs (acquires) pixel signals corresponding to one frame. More specifically, the number of times is the number of times corresponding to a quotient acquired by dividing a time acquired by subtracting a pixel signal reading period from a time in which pixel signals corresponding to one frame are acquired by the distance image sensor 32 by a time in which the light source device 21 emits laser light having a pulse shape, in other words, a pulse period time To of the light pulse PO. In addition, in the distance image sensor 32, the electric charge accumulated (added up) in each electric charge accumulating unit CS increases as the number of times of electric charge distribution driving increases, whereby the sensitivity thereof becomes higher. In this way, the resolution of the distance to a subject S that is to be measured can be improved in the distance image sensor 32.

Subsequently, driving (controlling) of pixel circuits 321 in a pixel signal reading period in which voltage signals corresponding to the electric charges distributed to the electric charge accumulating units CS included in the pixel signal reading units RU are sequentially output for each row of pixel circuits 321 disposed within the light receiving pixel unit 320 after the end of the electric charge accumulation period will be described. In the pixel signal reading period, by using so-called rolling driving in which pixel circuits 321 disposed within the light receiving pixel unit 320 are driven for each row, voltage signals corresponding to the electric charges accumulated (added up) and stored in the electric charge accumulating units CS included in pixel circuits 321 disposed in a corresponding row are output to the pixel signal processing circuit 325 in a row sequential manner.

In addition, as described above, in the distance image sensor 32, signal processing set in advance such as a noise suppression process and the like is performed for a voltage signal output by each pixel circuit 321 by the pixel signal processing circuit 325. Here, a correlated double sampling (CDS) process performed by the pixel signal processing circuit 325 as a noise suppression process is a process of taking a difference between a voltage signal corresponding to the electric charge accumulated (added up) and stored in the electric charge accumulating unit CS (hereinafter, referred to as a “distance pixel voltage signal PS”) and a voltage signal corresponding to the electric charge in a state in which the electric charge accumulating unit CS is reset (a reset state) (hereinafter, referred to as a “reset voltage signal PR”). For this reason, in a pixel signal reading period, a distance pixel voltage signal PS corresponding to each electric charge accumulating unit CS included in each pixel circuit 321 and each voltage signal of a reset voltage signal PR are output to the pixel signal processing circuit 325 in a row sequential manner.

In a pixel signal reading period represented in the timing diagram shown in FIG. 4, in a case of a plurality of pixel circuits 321 of y rows (here, y is an integer equal to or larger than “1”) in a vertical direction (a direction of arrangement of rows) and x columns (here, x is an integer equal to or larger than “1”) in a horizontal direction (a direction of arrangement of columns) of the light receiving pixel unit 320 are disposed, driving timings of the pixel circuits 321 in a case in which voltage signals including a distance pixel voltage signal PS(i) and a reset voltage signal PR(i) are output from pixel circuits 321(i) disposed in the i-th row (1≤i≤y) of the light receiving pixel unit 320 are shown. In addition, in the timing diagram shown in FIG. 4, voltage signals are sequentially output in order of the electric charge accumulating unit CS1(i), the electric charge accumulating unit CS2(i), and the electric charge accumulating unit CS3(i) included in each pixel circuit 321(i).

In a pixel signal reading period, first, in a period of time tR1 to time tR2, the vertical scanning circuit 323 outputs a distance pixel voltage signal PS1(i) from an output terminal O1(i) to the pixel signal processing circuit 325 through a vertical signal line. In this way, the pixel signal processing circuit 325 temporarily stores the distance pixel voltage signal PS1(i) output from the pixel signal reading unit RU1(i) through the vertical signal line.

Then, in a period of time tR2 to time tR3, the vertical scanning circuit 323 discharges electric charge of the electric charge accumulating unit CS1(i) included in the pixel circuit 321(i) by supplying a reset signal RST1(i), thereby performing resetting.

Thereafter, in a period of time tR3 to time tR4, the vertical scanning circuit 323 outputs a reset voltage signal PR1(i) from the output terminal O1(i) to the pixel signal processing circuit 325 through the vertical signal line. In this way, the pixel signal processing circuit 325 takes a difference between the distance pixel voltage signal PS1(i) that is temporarily stored and the reset voltage signal PR1(i) output from the pixel signal reading unit RU1(i) through the vertical signal line, in other words, noise included in a voltage signal corresponding to the electric charge that is accumulated (added up) and stored in the electric charge accumulating unit CS1(i) is suppressed.

Thereafter, in a period of time tR4 to time tR7, similar to the period of the time tR1 to the time tR4, the vertical scanning circuit 323 outputs a distance pixel voltage signal PS2(i) and a reset voltage signal PR2(i) from an output terminal O2(i) to the pixel signal processing circuit 325 through a vertical signal line. In addition, also in a period of time tR7 to time tR10, similar to the period of the time tR1 to the time tR4, the vertical scanning circuit 323 outputs a distance pixel voltage signal PS3(i) and a reset voltage signal PR3(i) from an output terminal O3(i) to the pixel signal processing circuit 325 through a vertical signal line.

Thereafter, the vertical scanning circuit 323 sequentially performs driving of pixel circuits 321 (hereinafter, referred to as “pixel signal reading driving”) similar to the period of the time tR1 to the time tR10 for pixel circuits 321 (for example, pixel circuits 321 disposed in the (i+1)-th row) disposed in another row of the light receiving pixel unit 320 and sequentially outputs voltage signals from all the pixel circuits 321 disposed within the light receiving pixel unit 320.

In accordance with such a driving (controlling) method (timings), the pixel driving circuit 326 performs distribution of electric charge generated and accumulated by the photo electric conversion device PD in each of the pixel circuits 321 disposed within the light receiving pixel unit 320 into pixel signal reading units RU a plurality of number of times.

In addition, the vertical scanning circuit 323 sequentially outputs voltage signals corresponding to the electric charges accumulated (added up) in the electric charge accumulating units CS included in the pixel signal reading units RU to the pixel signal processing circuit 325 through the vertical signal line.

In addition, the AD conversion circuit 329 performs an A/D conversion process for each voltage signal of which noise is suppressed for each row. Then, the horizontal scanning circuit 324 sequentially outputs voltage signals of each row after the AD conversion circuit 329 performs the A/D conversion process through a horizontal signal line in order of columns of the light receiving pixel unit 320, and accordingly, the distance image sensor 32 outputs pixel signals of all the pixel circuits 321 corresponding to one frame to the outside. In this way, in the distance image capturing device 1, pixel signals corresponding to one frame are output to the distance calculating unit 42 in order of so-called raster.

In addition, as can be understood from the driving (controlling) timings of the pixel circuits 321 shown in FIG. 4, three voltage signals corresponding to three pixel signal reading units RU (the electric charge accumulating units CS) included in a corresponding pixel circuit 321 are included in each of pixel signals corresponding to one frame. The distance calculating unit 42 calculates the distance from a subject S for each pixel signal, in other words, for each pixel circuit 321 on the basis of the pixel signals corresponding to one frame output from the distance image sensor 32.

Here, a method of calculating the distance between the distance image capturing device 1 and a subject S using the distance calculating unit 42 will be described. Here, the electric charge corresponding to background light before emission of a light pulse PO distributed to the electric charge accumulating unit CS1 of the pixel signal reading unit RU1 is assumed to be an electric charge Q1. In addition, an electric charge corresponding to background light distributed to the electric charge accumulating unit CS2 of the pixel signal reading unit RU2 and reflected light RL incident with a short delay time is assumed to be an electric charge Q2. Furthermore, an electric charge corresponding to background light distributed to the electric charge accumulating unit CS3 of the pixel signal reading unit RU3 and reflected light RL incident with a long delay time is assumed to be an electric charge Q3. The distance calculating unit 42 acquires a distance D from a subject S for each pixel circuit 321 using the following Equation (1).

D=(Q3−Q1)/(Q2+Q3−2Q1)×Dm (1)

In Equation (1) represented above, Dm represents a maximum distance that can be measured through emission of a light pulse PO (a maximum measurement distance). Here, the maximum measurement distance Dm is represented using the following Equation (2).

Dm=(c/2)Tw (2)

In Equation (2) represented above, c represents the velocity of light, and Tw represents a pulse width of a light pulse PO.

As described above, the distance image capturing device 1 acquires a distance D between the device and a subject S for each of the pixel circuits 321 disposed within the light receiving pixel unit 320 of the distance image sensor 32.

In addition, as described above, the configuration of pixel circuits disposed in the lattice shape in the distance image sensor 32 is not limited to the configuration including three pixel signal reading units RU1, RU2, and RU3 as shown in FIG. 3 and may be a pixel circuit 321 having a configuration including one photo electric conversion device PD and two or more pixel signal reading units RU distributing electric charge generated and accumulated by the photo electric conversion device PD. In such a case, in other words, also in a distance image sensor in which pixels including different numbers of pixel signal reading units RU are disposed, a method (timings) of driving (controlling) pixels can be easily realized by considering it to be similar to the method (timings) of driving (controlling) pixel circuits 321 in the distance image capturing device 1 shown in FIG. 4. More specifically, in a period in which a phase relation is maintained such that phases of drive signals input to a reading gate transistor G and a drain gate transistor GD included in each pixel signal reading unit RU do not overlap each other, by repeating electric charge distribution driving for pixels, similar to the distance image sensor 32, electric charge corresponding to light that corresponds to the electric charge accumulating unit CS included in each pixel signal reading unit RU can be accumulated (added up). Then, by sequentially outputting voltage signals from all the pixels through pixel signal reading driving, similar to the distance image sensor 32, pixel signals corresponding to one frame can be output to the outside of the distance image sensor. In this way, the distance calculating unit 42 can similarly acquire a distance D between the distance image capturing device 1 and a subject S for each pixel signal (for each pixel) on the basis of pixel signals corresponding to one frame output from a distance image sensor in which pixels configured to have different numbers of pixel signal reading units RU are disposed.

Generally, in order to accurately measure the distance to an object, a distance image sensor drives all the pixel circuits 321 of the light receiving pixel unit 320 at the same timing within the accumulation period in accordance with the global shutter system. In other words, the accumulation drive signals TX1, TX2, and TX3 and the reset drive signal RSTD are supplied to all the columns of the pixel circuits 321 in the array of the pixel circuits 321 having a lattice pattern at the same timing.

In FIG. 2 described above, for each column of pixel circuits 321, each of four timing adjusting circuits 326C and four driver circuits 326D supplies accumulation drive signals TX1, TX2, and TX3 and the reset drive signal RSTD to each of the pixel circuits 321 in the column described above.

The reading gate transistors G1, G2, and G3 shown in FIG. 3 are respectively controlled in accordance with the accumulation drive signals TX1, TX2, and TX3 described above, and electric charge is accumulated in the accumulation units CS1, CS2, and CS3 for every accumulation period within a frame period.

The vertical scanning circuit 323 outputs voltages corresponding to the electric charges accumulated in the accumulation units CS1, CS2, and CS3 respectively from the source follower gate transistors SF1, SF2, and SF3 to the pixel signal processing circuit 325.

By outputting the selection drive signals SEL1, SEL2, and SEL3, the vertical scanning circuit 323 controls the selection gate transistors SL1, SL2, and SL3. In accordance with this, the selection gate transistors SL1, SL2, and SL3 respectively output voltages corresponding to the electric charges accumulated in the accumulating units CS1, CS2, and CS3 to the pixel signal processing circuit 325 from the output terminals O1, O2, and O3 as distance pixel voltage signals PS1, PS2, and PS3 (in order to clearly indicate analog voltages, hereinafter referred to as input voltages VA(CS1), VA(CS2), and VA(CS3)).

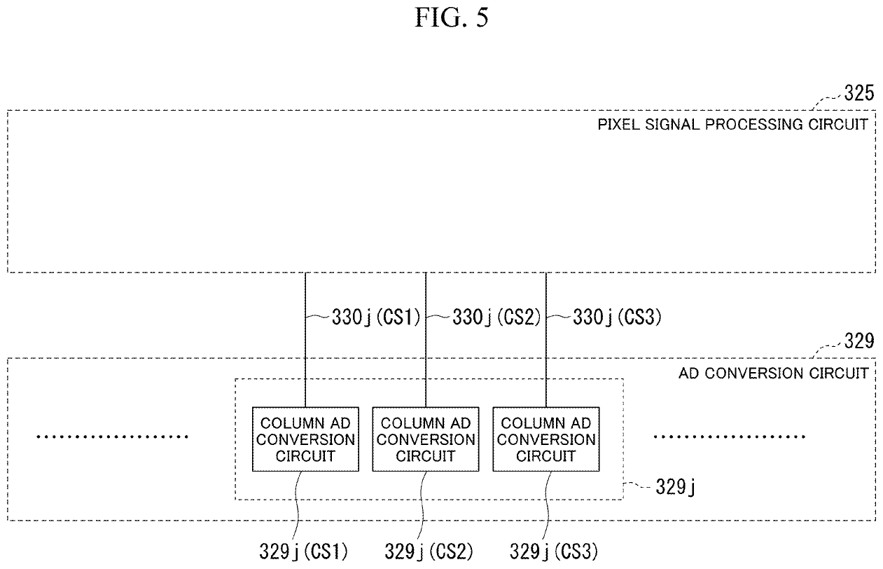

FIG. 5 is a conceptual diagram illustrating an example configuration of an AD conversion circuit that performs AD conversion of an input voltage supplied from a pixel signal processing circuit according to an embodiment of the present invention.

The AD conversion circuit 329 includes a column AD conversion unit 329j for each column j in the pixel circuits 321 arranged in a lattice shape. The vertical signal line 330 (FIG. 2) is composed of three vertical signal lines. For example, the vertical signal line 330j corresponding to a column j of the pixel circuits 321 arranged in a lattice pattern includes vertical signal lines 330j(CS1), 330j(CS2), and 330j(CS3).

The column AD conversion unit 329j includes column AD conversion circuits 329j(CS1), 329j(CS2), and 329j(CS3) that are disposed in correspondence with the output terminals O1, O2, and O3 in the column j and are connected through the vertical signal lines 330j(CS1), 330j(CS2), and 330j(CS3).

An analog voltage corresponding to the electric charge accumulated in the electric charge accumulating unit CS1 after signal processing supplied from the pixel signal processing circuit 325 is supplied to the column AD conversion circuits 329j(CS1), 329j(CS2), and 329j(CS3) through the vertical signal lines 330j(CS1), 330j(CS2), and 330j(CS3) as input voltages VA(CS1), VA(CS2), and VA(CS3). The vertical signal lines 330j(CS1), 330j(CS2), and 330j(CS3) are respectively connected to the output terminals O1, O2, and O3 of the pixel circuit 321 shown in FIG. 3.

Then, the column AD conversion circuits 329j(CS1), 329j(CS2), and 329j(CS3) correct converted voltages VD(CS1), VD(CS2), and VD(CS3) having digital values acquired by performing AD conversion of the input voltages VA(CS1), VA(CS2), and VA(CS3) and output corrected converted voltages as pixel signals of output digital values OD(CS1), OD(CS2), and OD(CS3).

In this embodiment, when the distance between a subject S and the distance image sensor 32 is measured, the measurement is performed using one of a normal mode and a detailed measurement mode as a measurement mode.

In the normal mode, it is determined whether a distance D to a subject S that is desired to be measured is located in a short-distance range or a long-distance range.

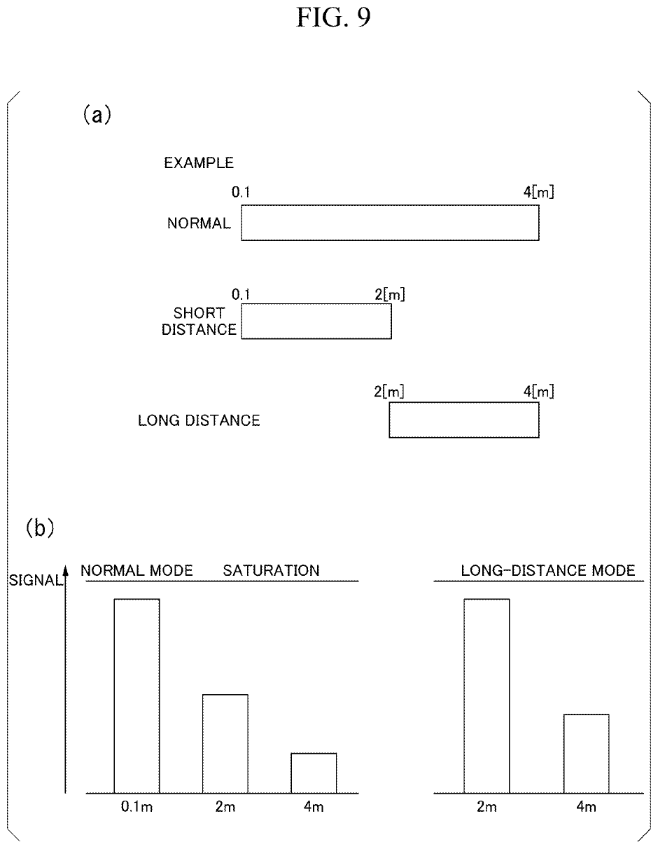

Then, two sub-measurement ranges are generated by dividing a maximum measurement distance of the distance image sensor 32 into two parts, a sub-measurement range in which the distance to the subject S is smaller is set as the short-distance range, and a sub-measurement range in which the distance to the subject S is larger is set as the long-distance range (subsection (a) of FIG. 9 to be described below).

As the detailed measurement mode described above, there are two modes including a short-distance mode and a long-distance mode. The short-distance mode is a detailed measurement mode in which a distance D to the subject S in the short-distance range is measured. In addition, the long-distance mode is a detailed measurement mode in which a distance D to the subject S in the long-distance range is measured.

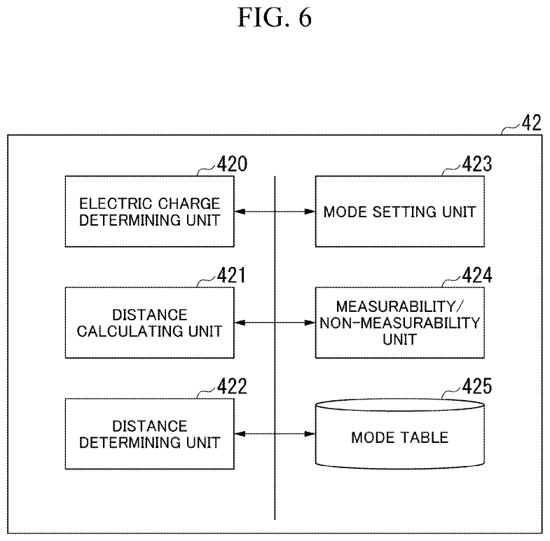

FIG. 6 is a block diagram illustrating an example configuration of the distance calculating unit 42 of the distance image processing unit 4 according to this embodiment.

The distance calculating unit 42 includes an electric charge determining unit 420, a distance calculating unit 421, a distance determining unit 422, a mode setting unit 423, a measurability/non-measurability unit 424, and a mode table 425.

In a case in which the measurement mode is the short-distance mode, the electric charge determining unit 420 determines whether or not the output digital value OD(CS2) exceeds the output digital value OD(CS1) by comparing the output digital value OD(CS2) with the output digital value OD (CS1) for each pixel circuit 321. Here, in a case in which the output digital value OD(CS2) exceeds the output digital value OD(CS1), the electric charge Q2 is added to the electric charge Q1, and an electric charge generated by the reflected light RL is included therein, in other words, it indicates that the distance to the subject S can be measured using the electric charges Q2 and Q3. On the other hand, in a case in which the output digital value OD(CS2) is equal to or smaller than the output digital value OD(CS1), and an electric charge generated by the reflected light RL is not included therein without the electric charge Q2 having been added to the electric charge Q1, in other words, it indicates that the distance to the subject S cannot be measured using the electric charges Q2 and Q3. In a case in which this output digital value OD(CS2) is equal to or smaller than the output digital value OD(CS1), the subject S is located not in the short-distance range that is a sub-measurement range of a short distance but in the long-distance range that is a sub-measurement range of a long distance.

On the other hand, in a case in which the measurement mode is the long-distance mode, the electric charge determining unit 420 determines whether the output digital value OD(CS1) exceeds the output digital value OD(CS3) by comparing the output digital value OD(CS3) with the output digital value OD(CS1) for each pixel circuit 321. Here, in a case in which the output digital value OD(CS1) is equal to or smaller than the output digital value OD(CS3), the electric charge Q3 is added to the electric charge Q1, and an electric charge generated by the reflected light RL is included therein, in other words, it indicates that the distance to the subject S can be measured using the electric charges Q2 and Q3. On the other hand, in a case in which the output digital value OD(CS1) exceeds the output digital value OD(CS3), the electric charge Q1 includes an electric charge generated by the reflected light RL in addition to an electric charge according to background light, in other words, it indicates that the distance to the subject S cannot be measured using the electric charges Q2 and Q3. In a case in which this output digital value OD(CS1) exceeds the output digital value OD(CS3), the subject S is located not in the sub-measurement range of a long distance but in the short-distance range that is the sub-measurement range of a short distance.

Then, after the determination described above is performed, in a case in which a result of the determination of the electric charges indicates that the distance can be measured, the electric charge determining unit 420 performs control for calculation of the distance for the distance calculating unit 421.

On the other hand, in a case in which the result of the determination of the electric charges indicates that the distance cannot be measured, the electric charge determining unit 420 does not cause the distance calculating unit 421 to calculate the distance and outputs control information for setting a numerical value set in advance as a calculation result. At this time, for example, the distance calculating unit 421 outputs a numerical value of a maximum distance in the case of the short-distance mode and outputs a minimum numerical value in the case of the long-distance mode as a result of calculation.

In addition, in a case in which the measurement mode is the normal mode, the electric charge determining unit 420 does not perform the process of determining electric charges and outputs control information causing the distance calculating unit 421 to perform a predetermined calculation process.

The distance calculating unit 421 acquires a distance D to a subject S for each pixel circuit 321, which has already been described in the distance calculation process of the distance calculating unit 42, using Equation (1) described above in the case of the normal mode.

In addition, in a case in which control not performing calculation is performed from the electric charge determining unit 420, the distance calculating unit 421 does not perform calculation using the corresponding output digital values OD(CS1), OD(CS2), and OD(CS3) and outputs a numerical value set in advance as a result of the calculation.

The distance determining unit 422, for example, determines whether a distance D of pixels in an attention area, which has been calculated by the distance calculating unit 421, is included in the short-distance range or the long-distance range. The attention area described above represents an area desired to be imaged in detail (a distance measurement target) in a distance image to be imaged.

In this embodiment, a distance range that is a range from the distance image capturing device 1 to a maximum measurement distance (Dm) that is measurable for the distance image capturing device 1 is divided into a plurality of sub-measurement ranges having the same width. For example, in a case in which the distance range is 0 m to 4 m, the distance range is divided into two sub-measurement ranges, in other words, is divided into a short-distance range over 0 m and less than 2 m and a long-distance range equal to or larger than 2 m and less than 4 m as two parts. In this embodiment, although the distance range is divided into two parts, the distance range may be configured to be divided into three or more parts.

In accordance with the sub-measurement range, a pulse width Tsw of each of the light pulse PO and the accumulation drive signals TX1, TX2, and TX3 is set.

In other words, in a case in which the division number is denoted by n, by using Equation (2) described above, a distance Dsm of a width of each sub-measurement range becomes a distance of Dm/n, and the pulse width Tsw becomes (Dm/n)×(2/c).

Then, the distance determining unit 422 determines whether a distance D of a pixel in an attention area is included in one of the sub-measurement ranges, for example, whether the distance is included in the short-distance range or the long-distance range and outputs measurement range information of a result of the determination to the mode setting unit 423.

In addition, in a case in which the distance D is unknown, the distance determining unit 422 outputs measurement range information indicating being in a distance range corresponding to the maximum measurement distance Dm to the mode setting unit 423.

For this reason, the distance calculating unit 421 acquires a distance D by using the following Equation (3) in the case of the short-distance mode and by using the following Equation (4) in the case of the long-distance mode. In the following Equations (3) and (4), Dsm represents a maximum measurement distance in the width of the sub-measurement range. This maximum measurement distance Dsm is acquired using Equation (5). Tsw is the pulse width of a light pulse PO in the detailed measurement mode.

D=(Q3−Q1)/(Q2+Q3−2Q1)×Dsm (3)

D=Dsm+(Q3−Q1)/(Q2+Q3−2Q1)×Dsm (4)

Dsm=(c/2)Tsw (5)

The mode setting unit 423 determines whether the measurement mode is set to the normal mode or the detailed measurement mode on the basis of the measurement range information supplied from the distance determining unit 422.

Here, in this embodiment, as measurement modes, the normal mode and the detailed measurement mode described above are provided.

In a case in which the measurement range information indicating measurement in a measurement range corresponding to the maximum measurement distance Dm is supplied from the distance determining unit 422, the mode setting unit 423 reads a mode setting value of the normal mode from the mode table 425.

On the other hand, in a case in which the measurement range information indicating that a mode setting in a sub-measurement range corresponding to the distance measured in the normal mode is performed is supplied from the distance determining unit 422, the mode setting unit 423 reads a mode setting value corresponding to this sub-measurement range from the mode table 425.

The mode setting value is a combination of the pulse width Tw described above and a phase (output timing) of a light pulse PO. In addition, the mode setting value is set in the mode table 425 in association with each of the normal mode in a distance range and a detailed measurement mode in each sub-measurement range.

The measurability/non-measurability unit 424 determines whether or not a distance of a pixel in an attention area is included in the short-distance range in the case of the short-distance mode or whether or not the distance is included in the long-distance range in the case of the long-distance mode, in other words, in accordance with the current detailed measurement mode.

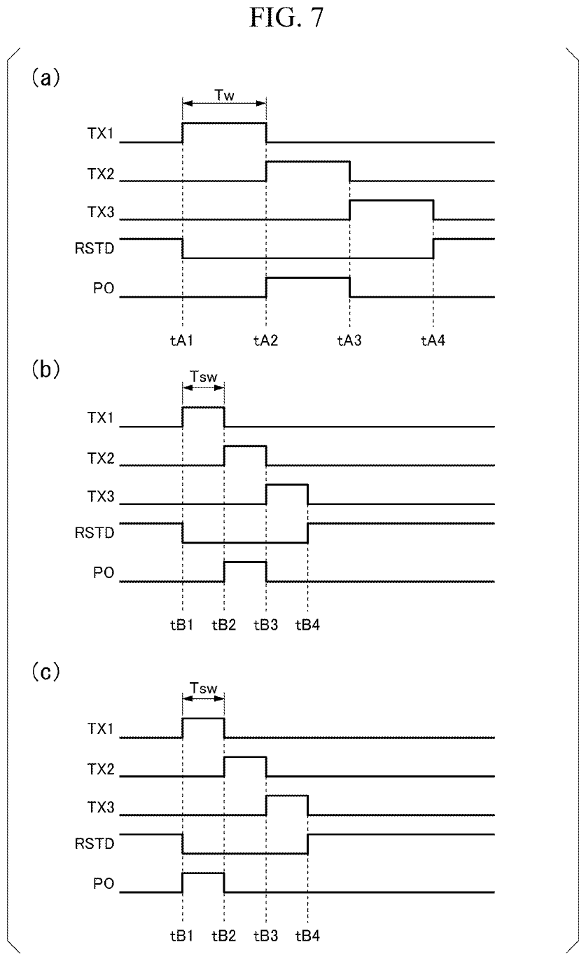

FIG. 7 is a timing diagram illustrating a phase of a light pulse PO in each of the normal mode, the short-distance mode, and the long-distance mode in an electric charge accumulation period according to this embodiment.

Subsection (a) of FIG. 7 illustrates a pulse width Tw and a phase of a light pulse PO of a mode setting value in the normal mode. Subsection (b) of FIG. 7 illustrates a pulse width Tsw and a phase of a light pulse PO of a mode setting value in the short-distance mode. Subsection (c) of FIG. 7 illustrates a pulse width Tsw and a phase of a light pulse PO of a mode setting value in the long-distance mode.

Subsection (a) of FIG. 7 is a timing diagram illustrating timings for driving a pixel circuit 321 disposed within the light receiving pixel unit 320 of the distance image sensor 32 in the normal mode. A pulse width Tw of each drive signal in the normal mode is set to Dm×(2/c). In addition, the phase of the light pulse PO is the same as that of the accumulation drive signal TX2. Subsection (a) of FIG. 7 illustrates timings of a light pulse PO emitted onto a subject S by the light source unit 2 together with timings of a drive signal of the pixel circuit 321 at the time of outputting pixel signals corresponding to one frame using the distance image sensor 32 in the normal mode.

A reset drive signal RSTD is supplied to the pixel circuit 321 until immediately before a time tA1. At the time tA1, the pixel driving circuit 326 distributes electric charge generated by a photo electric conversion device PD in accordance with background light to the electric charge accumulating unit CS1 using the accumulation drive signal TX1. At a time tA2, the pixel driving circuit 326 distributes electric charge generated by the photo electric conversion device PD in accordance with reflected light RL reflected from the subject S to the electric charge accumulating unit CS2 using the accumulation drive signal TX2. At a time tA3, the pixel driving circuit 326 distributes electric charge generated by the photo electric conversion device PD in accordance with reflected light RL reflected from the subject S to the electric charge accumulating unit CS3 using the accumulation drive signal TX3. At a time tA4, in accordance with supply of the reset drive signal RSTD, electric charge generated by the photo electric conversion device PD is eliminated (reset).

Subsection (b) of FIG. 7 is a timing diagram illustrating timings for driving a pixel circuit 321 disposed within the light receiving pixel unit 320 of the distance image sensor 32 in the short-distance mode. A pulse width Tsw of each drive signal in the short-distance mode is set to (Dsm)×(2/c), Dm/c. Here, Dsm is Dm/n, and n is the division number, and, for example, in a case in which Dm is 4 m, and the division number n is 2, Dsm of each of the short-distance range and the long-distance range is 2 m. In addition, since the distance range is divided into two parts, that is, the sub-measurement ranges of the short-distance range and the long-distance range, the pulse width Tsw is ½ of the pulse width Tw. The phase of the light pulse PO is the same as that of the accumulation drive signal TX2. Subsection (b) of FIG. 7 illustrates timings of a light pulse PO emitted onto a subject S by the light source unit 2 together with timings of a drive signal of the pixel circuit 321 at the time of causing the distance image sensor 32 to output pixel signals corresponding to one frame in the short-distance mode. Here, the reason for setting the phase of the light pulse PO to be the same as that of the accumulation drive signal TX2 is that the sub-measurement range in the short-distance mode (the short-distance range) satisfies 0 (m)<L<2 (m).

A reset drive signal RSTD is supplied to the pixel circuit 321 until immediately before a time tB1. At the time tB1, the pixel driving circuit 326 distributes electric charge generated by a photo electric conversion device PD in accordance with background light to the electric charge accumulating unit CS1 using the accumulation drive signal TX1. At a time tB2, the pixel driving circuit 326 distributes electric charge generated by the photo electric conversion device PD in accordance with reflected light RL reflected from the subject S to the electric charge accumulating unit CS2 using the accumulation drive signal TX2. At a time tB3, the pixel driving circuit 326 distributes electric charge generated by the photo electric conversion device PD in accordance with reflected light RL reflected from the subject S to the electric charge accumulating unit CS3 using the accumulation drive signal TX3. In addition, at a time tB4, in accordance with supply of the reset drive signal RSTD, electric charge generated by the photo electric conversion device PD is eliminated. In accordance with the process described above, reflected light RL from a subject S located at a distance of less than 2 m from the pixel circuit 321 causes electric charge to be distributed to and accumulated in the electric charge accumulating units CS2 and CS3 in accordance with the accumulation drive signals TX2 and TX3, and the distance image processing unit 4 acquires a distance D between the pixel circuit 321 and the subject S in accordance with Equation (3).

Subsection (c) of FIG. 7 is a timing diagram illustrating timings for driving a pixel circuit 321 disposed within the light receiving pixel unit 320 of the distance image sensor 32 in the short-distance mode. Similar to the pulse width in the short-distance mode, a pulse width Tsw of each drive signal in the long-distance mode is set to Dsm/c. In addition, a phase of the light pulse PO is the same as that of the accumulation drive signal TX1.

Here, the reason for configuring the phase of the light pulse PO to be the same as not the phase of the accumulation drive signal TX2 but the phase of the accumulation drive signal TX1 is that the sub-measurement range L in the long-distance mode (the long-distance range) is 2 (m)≤L<4 (m). For this reason, the distance image processing unit 4 causes the light source unit 2 to emit a light pulse PO at the timing of the accumulation drive signal TX1 such that reflected light RL from a subject S located at a distance of 2 m or more is incident at a timing before a time corresponding to 4 m (=Dm/c) in which light reciprocates the distance of 2 m, that is, at the timing of the accumulation drive signal TX2 for distributing electric charge.

Then, similar to the case of the short-distance mode shown in subsection (b) of FIG. 7, a reset drive signal RSTD is supplied to the pixel circuit 321 until immediately before a time tB1. At the time tB1, the pixel driving circuit 326 distributes electric charge generated by a photo electric conversion device PD in accordance with background light to electric charge accumulating unit CS1 using the accumulation drive signal TX1. At a time tB2, the pixel driving circuit 326 distributes electric charge generated by the photo electric conversion device PD in accordance with reflected light RL reflected from the subject S to the electric charge accumulating unit CS2 using the accumulation drive signal TX2. At a time tB3, the pixel driving circuit 326 distributes electric charge generated by the photo electric conversion device PD in accordance with reflected light RL reflected from the subject S to the electric charge accumulating unit CS3 using the accumulation drive signal TX3. In accordance with the process described above, reflected light RL from a subject S located at the distance of 2 m or more from the pixel circuit 321 causes electric charge to be distributed to and accumulated in the electric charge accumulating units CS2 and CS3 in accordance with the accumulation drive signals TX2 and TX3, and the distance image processing unit 4 acquires a distance D between the pixel circuit 321 and the subject S using Equation (4).

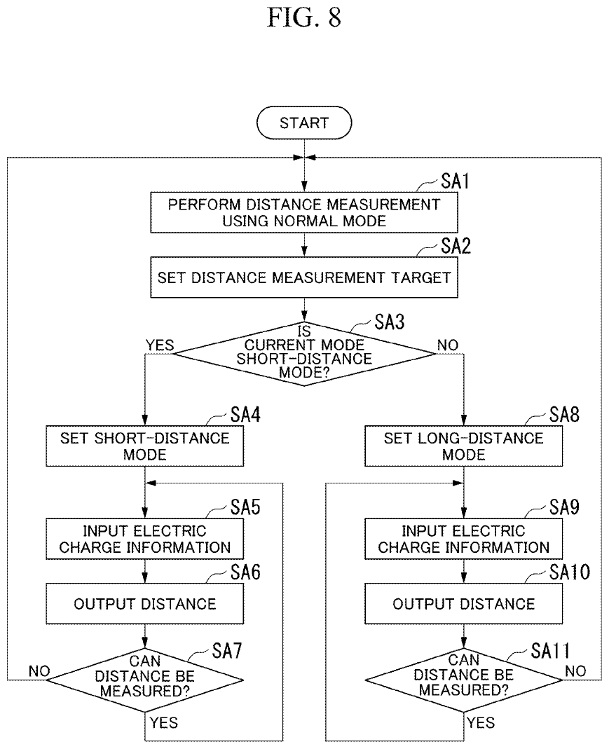

Hereinafter, a distance measurement process of the distance image processing unit 4 according to this embodiment will be described with reference to FIG. 8. FIG. 8 is a flowchart illustrating an operation example of the distance measurement process using the distance image capturing device 1 according to this embodiment. The distance measurement described below is performed for each of pixel signals of all the pixel circuits 321 of the light receiving pixel unit 320 of the distance image sensor 32 (for each frame of a captured image).

Step SA1: The mode setting unit 423 performs initial setting of the measurement mode for performing distance measurement and reads a pulse width Tw and a phase in the normal mode from the mode table 425. Then, the mode setting unit 423 outputs the pulse width Tw and the phase that have been read to the timing control unit 41. In accordance with this, the timing control unit 41 supplies the accumulation drive signals TX1, TX2, and TX3 and the reset drive signal RSTD to the distance image sensor 32 and outputs a drive signal for emitting a light pulse PO to the light source device 21 (the waveform shown in subsection (a) of FIG. 7).

Pixel signals of output digital values OD(CS1), OD(CS2), and OD(CS3) corresponding to electric charges Q1, Q2, and Q3 are supplied to the distance calculating unit 421 from the distance image sensor 32.

The distance calculating unit 421 calculates the distance from the distance image sensor 32 to a subject S by substituting the output digital values OD(CS1), OD(CS2), and OD(CS3) into Equation (1) as the electric charges Q1, Q2, and Q3 (distance measurement).

Step SA2: A user, for example, inputs information of an attention area (a distance measurement target) that is an area desired to be imaged in detail in a distance image to the distance image capturing device 1 using an input means not shown.

In addition, a configuration in which the information of the attention area described above in the distance image is set for the distance image capturing device 1 in advance, and the attention area set for the distance image is surrounded by a frame image may be employed. In such a case, a user adjusts the imaging direction of the distance image capturing device 1 such that a target for which the distance is to be measured in detail by him/her enters the frame image described above.

Step SA3: The distance determining unit 422 compares the distance of a pixel of the input attention area described above with the sub-measurement range of each of the short-distance mode and the long-distance mode. Here, the distance determining unit 422, for example, determines whether or not the distance of the pixel of the attention area is included in the detailed sub-measurement range of the short-distance mode.

At this time, in a case in which the distance of the pixel of the attention area is included in the short-distance range that is the sub-measurement range of the short-distance mode, the distance determining unit 422 causes the process to proceed to Step SA4.

On the other hand, in a case in which the distance of the pixel of the attention area is not included in the short-distance range of the short-distance mode (in a case in which the distance is included in the long-distance range that is the sub-measurement range of the long-distance mode), the distance determining unit 422 causes the process to proceed to Step SA8.

Step SA4: In order to change the measurement mode for performing distance measurement from the normal mode to the short-distance mode of the detailed measurement mode, the mode setting unit 423 reads a pulse width Tsw and a phase of the short-distance mode from the mode table 425. Then, the mode setting unit 423 outputs the pulse width Tsw and the phase that have been read to the timing control unit 41. In accordance with this, the timing control unit 41 supplies the accumulation drive signals TX1, TX2, and TX3 and the reset drive signal RSTD corresponding to the pulse width Tsw and the phase that have been supplied to the distance image sensor 32 and outputs a drive signal for emitting a light pulse PO to the light source device 21 (the waveform shown in subsection (b) of FIG. 7).

Step SA5: In the short-distance mode, after number of times of distribution corresponding to one frame ends, the distance image sensor 32 outputs pixel signals of the output digital values OD(CS1), OD(CS2), and OD(CS3) respectively corresponding to the electric charges Q1, Q2, and Q3 to the distance image processing unit 4.

In accordance with this, the distance calculating unit 421 inputs the output digital values OD(CS1), OD(CS2), and OD(CS3) respectively corresponding to the electric charges Q1, Q2, and Q3 acquired in the short-distance mode.

Step SA6: Since the current measurement mode is the short-distance mode, the electric charge determining unit 420 compares the output digital value OD(CS2) for each pixel circuit 321 with the output digital value OD(CS1) and determines whether or not the output digital value OD(CS2) exceeds the output digital value OD(CS1).

Then, in a case in which the distance to the subject S can be measured using the electric charges Q2 and Q3, the electric charge determining unit 420 outputs control information for causing the distance calculating unit 421 to calculate the distance.

In a case in which the control information for performing calculation of a distance is input, the distance calculating unit 421 outputs a distance D calculated by substituting the input electric charges Q1, Q2, and Q3 into Equation (3) (distance measurement according to the short-distance mode).

On the other hand, in a case in which the distance to the subject S cannot be measured using the electric charges Q2 and Q3, the electric charge determining unit 420 outputs control information for setting a predetermined numerical value (a value out of the range) as a calculation result to the distance calculating unit 421.

The distance calculating unit 421 does not calculate a distance D using the input electric charges Q1, Q2, and Q3 and outputs the numerical value set in advance as a calculation result.

For all the pixels of a captured image, the electric charge determining unit 420 compares the electric charges Q1 and Q2 with each other, and the distance calculating unit 421 calculates a distance D corresponding to the comparison result.

Step SA7: The measurability/non-measurability unit 424 determines whether or not a distance D of a pixel in the attention area can be measured within the short-distance range in the short-distance mode, in other words, whether or not the distance D is a value out of the range.

At this time, in a case in which the distance D is not a value out of the range, the subject S of the attention area is included in the distance within the short-distance range, and measurement can be performed using the short-distance mode, and thus the measurability/non-measurability unit 424 causes the process to proceed to Step SA5.

On the other hand, in a case in which the distance D is a value out of the range, the subject S of the attention area is not included in the distance within the short-distance range, and measurement cannot be performed using the short-distance mode, and thus the measurability/non-measurability unit 424 causes the process to proceed to Step SA1.

Step SA8: In order to change the measurement mode for performing distance measurement from the normal mode to the long-distance mode of the detailed measurement mode, the mode setting unit 423 reads a pulse width Tsw and a phase of the long-distance mode from the mode table 425. Then, the mode setting unit 423 outputs the pulse width Tsw and the phase that have been read to the timing control unit 41. In accordance with this, the timing control unit 41 supplies the accumulation drive signals TX1, TX2, and TX3 and the reset drive signal RSTD corresponding to the pulse width Tsw and the phase that have been supplied to the distance image sensor 32 and outputs a drive signal for emitting a light pulse PO to the light source device 21 (the waveform shown in subsection (c) of FIG. 7).

Step SA9: After the number of times of distribution corresponding to one frame ends in the long-distance mode, the distance image sensor 32 outputs pixel signals of output digital values OD(CS1), OD(CS2), and OD(CS3) respectively corresponding to the electric charges Q1, Q2, and Q3 to the distance image processing unit 4.

In accordance with this, the distance calculating unit 421 inputs pixel signals of the output digital values OD(CS1), OD(CS2), and OD(CS3) respectively corresponding to the electric charges Q1, Q2, and Q3 acquired in the long-distance mode from the distance image sensor 32.

Step SA10: Since the current measurement mode is the long-distance mode, the electric charge determining unit 420 determines whether or not the output digital value OD(CS3) exceeds the output digital value OD(CS1) by comparing the output digital value OD(CS3) with the output digital value OD(CS1).

Then, in a case in which the distance to the subject S can be measured using the electric charges Q2 and Q3, the electric charge determining unit 420 outputs control information for causing the distance calculating unit 421 to calculate the distance.

In a case in which the control information for performing calculation of a distance is input, the distance calculating unit 421 outputs a distance D calculated by substituting the input electric charges Q1, Q2, and Q3 into Equation (4) (distance measurement according to the long-distance mode).

On the other hand, in a case in which the distance to the subject S cannot be measured using the electric charges Q2 and Q3, the electric charge determining unit 420 outputs control information for setting a predetermined numerical value (a value out of the range) as a calculation result to the distance calculating unit 421.

The distance calculating unit 421 does not calculate a distance D using the input electric charges Q1, Q2, and Q3 and outputs the numerical value set in advance as a calculation result.

For all the pixels of a captured image, the electric charge determining unit 420 compares the electric charges Q1 and Q2 with each other, and the distance calculating unit 421 calculates a distance D corresponding to the comparison result.

Step SA11: The measurability/non-measurability unit 424 determines whether or not a distance D of a pixel in the attention area can be measured within the long-distance range in the long-distance mode, in other words, whether or not the distance D is a value out of the range.

At this time, in a case in which the distance D is not a value out of the range, the subject S of the attention area is included in the distance within the long-distance range, and measurement can be performed using the long-distance mode, and thus the measurability/non-measurability unit 424 causes the process to proceed to Step SA9.

On the other hand, in a case in which the distance D is a value out of the range, the subject S of the attention area is not included in the distance within the long-distance range, and measurement cannot be performed using the long-distance mode, and thus the measurability/non-measurability unit 424 causes the process to proceed to Step SA1.

FIG. 9 is a diagram illustrating effects of distance measurement performed via the detailed measurement mode according to the distance image capturing device 1 according to this embodiment. Subsection (a) of FIG. 9 illustrates measurement ranges of the normal mode, the short-distance mode, and the long-distance mode according to this embodiment. Subsection (b) of FIG. 9 illustrates an electric charge corresponding to the distance to a subject S in each of the normal mode and the long-distance mode.

In this embodiment, as one example, 0.1 m to 4 m (0.1 [m]<L<4 [m]) that is the measurement range L in the normal mode is divided into sub-measurement ranges of a short-distance range of 0.1 m to 2 m (0.1 [m]<L<2 [m]) and a long-distance range of 2 m to 4 m (2 [m]≤L<4 [m]).

Then, for the measurement range in the normal mode, sub-measurement ranges that can be measured are narrowly set, and, in order to perform measurement of a distance in this sub-measurement range, the pulse width is shortened from Tw to Tsw, and the width of the light pulse PO is shortly set to be in correspondence with measurement of a distance in the sub-measurement range.

According to the configuration described above, in this embodiment, in a case in which switching from the normal mode to the detailed measurement mode is performed, by shortening the pulse width Tw to the pulse width Tsw, the intensity of the light pulse can be increased without changing the power consumption of the light source device 21. By increasing the intensity of the light pulse, the ratio of the electric charge according to reflected light RL to the electric charge according to background light can be increased in the electric charges Q2 and Q3, and, by increasing the S/N ratio of the intensity of the reflected light RL, the accuracy of a measured distance can be improved.

In addition, in this embodiment, by setting the detailed measurement mode, when the distance to a subject S is measured in the long-distance range, reflected light RL from the subject S in the short-distance range is not input, and thus the S/N ratio of the reflected light RL from the subject S in the long-distance range can be improved. In other words, in the normal mode, the intensity of the reflected light RL from the subject S in the short-distance range is large, and thus the relative intensity of the reflected light RL at a long distance is decreased, and the S/N ratio of the distance D acquired from Equation (1) is increased.

However, the distance is calculated using Equation (4) using the electric charges Q2 and Q3 of the reflected light RL from the subject S in the long-distance range, and thus the electric charge generated by the reflected light RL having a high intensity at a short distance is not included, and the accuracy (resolution) of measurement of the distance can be improved.

In addition, in this embodiment, the number of times of distribution per one frame of the distance image is set such that the amount of accumulation of the electric charge accumulating unit CS is not saturated.

As shown in subsection (b) of FIG. 9, in the normal mode, the number of times of distribution for which the amount of accumulation of the electric charge accumulating unit CS is not saturated is set in correspondence with electric charge generated in accordance with reflected light RL reflected from the subject S located at a short distance, for example, at the distance of 0.1 m from the distance image sensor 32. For this reason, the intensity of reflected light RL from a subject S located at the distance from the distance image sensor 32, for example, a distance of 2 m and 4 m is low, and thus the electric charge is relatively suppressed, and the S/N ratio becomes lower as the distance becomes shorter.

In this embodiment, by dividing the measurement range into the short-distance range and the long-distance range, in the case of measurement in the long-distance mode, electric charge generated in accordance with reflected light RL from a subject S within the short-distance range is not accumulated in the electric charge accumulating unit CS of the distance image sensor 32, and thus only electric charge generated in accordance with reflected light RL having a low intensity in the long-distance range is accumulated, and the amount of accumulation of the electric charge accumulating unit CS is suppressed, and the pulse width Tw is shortened to be the pulse width Tsw, whereby the number of times of distribution in a frame period in which a distance image of the same one frame is captured can be increased more than that of the normal mode. In accordance with this, the electric charge according to reflected light RL for 2 m, 4 m, or the like within the long-distance range can be increased, and, by improving the S/N ratio, the accuracy (resolution) of measurement of a distance can be improved.

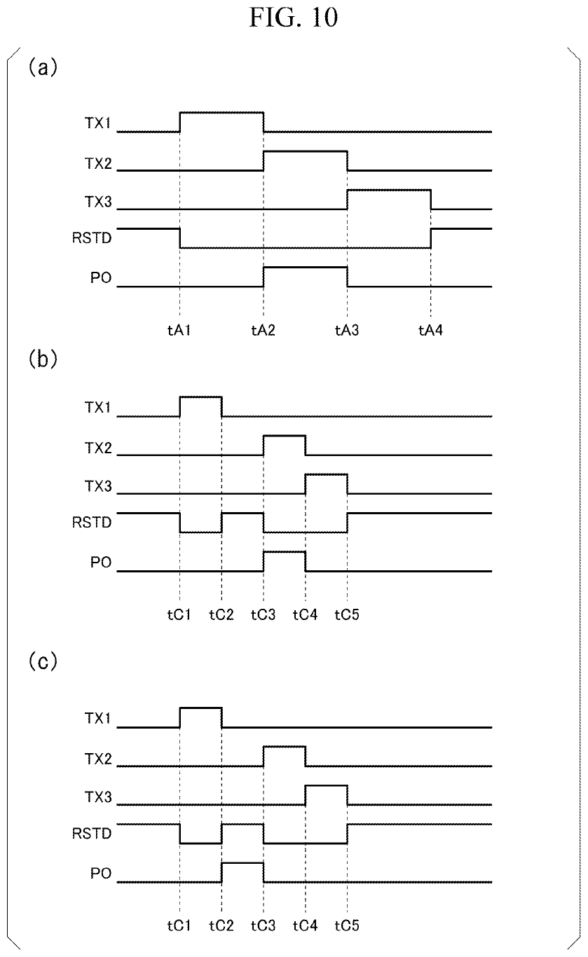

FIG. 10 is a timing diagram illustrating a phase of a light pulse PO in each of the normal mode, the short-distance mode, and the long-distance mode in an electric charge accumulation period in another configuration according to this embodiment.

Subsection (a) of FIG. 10 is similar to subsection (a) of FIG. 7 and illustrates a pulse width Tw and a phase of a light pulse PO of the mode setting value in the normal mode. Subsection (b) of FIG. 10 illustrates a pulse width Tsw and a phase of a light pulse PO of the mode setting value in the short-distance mode. Subsection (c) of FIG. 10 illustrates a pulse width Tsw and a phase of a light pulse PO of the mode setting value in the long-distance mode. Since subsection (a) of FIG. 10 is similar to subsection (a) of FIG. 7, a description thereof will be omitted.

Subsection (b) of FIG. 10 is a timing diagram illustrating timings for driving the pixel circuit 321 disposed within the light receiving pixel unit 320 of the distance image sensor 32 in the short-distance mode. A pulse width Tsw of each drive signal in the short-distance mode is set to (Dsm)×(2/c), Dm/c. Here, Dsm is Dm/n, and n is the division number, and, for example, in a case in which Dm is 4 m, and the division number n is 2, Dsm of each of the short-distance range and the long-distance range is 2 m. In addition, since the distance range is divided into two parts, that is, sub-measurement ranges of the short-distance range and the long-distance range, the pulse width Tsw is ½ of the pulse width Tw. The phase of the light pulse PO is the same as that of the accumulation drive signal TX2. Subsection (b) of FIG. 7 illustrates timings of a light pulse PO emitted onto a subject S by the light source unit 2 together with timings of a drive signal of the pixel circuit 321 at the time of causing the distance image sensor 32 to output pixel signals corresponding to one frame in the short-distance mode. Here, the reason for setting the phase of the light pulse PO to be the same as that of the accumulation drive signal TX2 is that the sub-measurement range in the short-distance mode (the short-distance range) satisfies 0 (m)<L<2 (m).

A reset drive signal RSTD is supplied to the pixel circuit 321 until immediately before a time tC1. At the time tC1, the pixel driving circuit 326 distributes electric charge generated by the photo electric conversion device PD in accordance with background light to the electric charge accumulating unit CS1 using the accumulation drive signal TX1. At a time tC2, a pulse of the reset drive signal RSTD is inserted, and electric charge generated by the photo electric conversion device PD is eliminated. Before electric charge used for acquiring a distance D is generated, the electric charge generated in accordance with background light is completely eliminated from the photo electric conversion device PD. In accordance with this, the electric charge that becomes noise according to the background light decreases in the electric charge Q2, and the accuracy of a distance D calculated using the electric charges Q2 and Q3 is improved. At a time tC3, the pixel driving circuit 326 distributes electric charge generated by the photo electric conversion device PD in accordance with reflected light RL reflected from the subject S to the electric charge accumulating unit CS2 using the accumulation drive signal TX2. At a time tC4, the pixel driving circuit 326 distributes electric charge generated by the photo electric conversion device PD in accordance with reflected light RL reflected from the subject S to the electric charge accumulating unit CS3 using the accumulation drive signal TX3. In addition, at a time tC5, in accordance with supply of the reset drive signal RSTD, electric charge generated by the photo electric conversion device PD is eliminated. In accordance with the process described above, reflected light RL from a subject S located at a distance of less than the pixel circuit 321 causes electric charge to be distributed to and accumulated in the electric charge accumulating units CS2 and CS3 in accordance with the accumulation drive signals TX2 and TX3, and the distance image processing unit 4 acquires a distance D between the pixel circuit 321 and the subject S in accordance with Equation (3).

Subsection (c) of FIG. 10 is a timing diagram illustrating timings for driving the pixel circuit 321 disposed within the light receiving pixel unit 320 of the distance image sensor 32 in the long-distance mode. Similar to the pulse width in the short-distance mode, a pulse width Tsw of each drive signal in the long-distance mode is set to Dsm/c.

A reset drive signal RSTD is supplied to the pixel circuit 321 until immediately before a time tC1. At the time tC1, the pixel driving circuit 326 distributes electric charge generated by a photo electric conversion device PD in accordance with background light to electric charge accumulating unit CS1 using the accumulation drive signal TX1. At a time tC2, a pulse of the reset drive signal RSTD having a pulse width Tsw is inserted, and electric charge generated by the photo electric conversion device PD is eliminated. At a time tC3, the pixel driving circuit 326 distributes electric charge generated by the photo electric conversion device PD in accordance with reflected light RL reflected from a subject S to the electric charge accumulating unit CS2 using the accumulation drive signal TX2. At a time tC4, the pixel driving circuit 326 distributes electric charge generated by the photo electric conversion device PD in accordance with reflected light RL reflected from a subject S to the electric charge accumulating unit CS3 using the accumulation drive signal TX3. In addition, at a time tC5, in accordance with supply of the reset drive signal RSTD, electric charge generated by the photo electric conversion device PD is eliminated. The phase of the light pulse PO is the same as the pulse of the reset drive signal RSTD at the time tC2.

Here, since the sub-measurement range L in the long-distance mode (the long-distance range) is 2 (m)≤L<4 (m), the phase of the light pulse PO is not that of the accumulation drive signal TX2 but that of the pulse of the reset drive signal RSTD at the time tC2. For this reason, the distance image processing unit 4 causes the light source unit 2 to emit a light pulse PO at the timing of the pulse of the reset drive signal RSTD at the time tC2 such that reflected light RL from a subject S located at a distance of 2 m or more is incident at a timing before a time corresponding to 4 m (=Dm)/c in which light reciprocates the distance of 2 m, in other words, at the timing of the accumulation drive signal TX2 at which electric charge is distributed.

In accordance with the process described above, reflected light RL from a subject S located at the distance of 2 m or more from the pixel circuit 321 causes electric charge to be distributed to and accumulated in the electric charge accumulating units CS2 and CS3 in accordance with the accumulation drive signals TX2 and TX3, and the distance image processing unit 4 acquires a distance D between the pixel circuit 321 and the subject S using Equation (4).

In addition, by inserting the pulse of the reset drive signal RSTD at the time tC2, electric charge generated in accordance with background light is completely eliminated from the photo electric conversion device PD before electric charge for acquiring the distance D is generated. In accordance with this, the electric charge that becomes noise according to the background light decreases in the electric charge Q2, and the accuracy of a distance D calculated using the electric charges Q2 and Q3 is improved.

### Second Embodiment

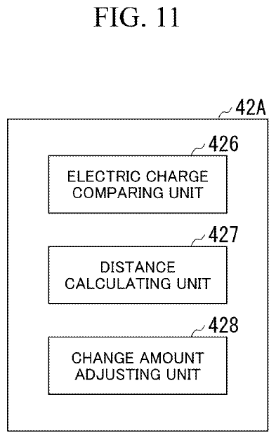

Hereinafter, a second embodiment of the present invention will be described with reference to the drawings. FIG. 11 is a block diagram illustrating an example configuration of a distance calculating unit 42A of a distance image processing unit 4 according to this embodiment. Hereinafter, a configuration and operations different from those of the first embodiment will be described.

The distance calculating unit 42A shown in FIG. 11 includes an electric charge comparing unit 426, a distance calculating unit 427, and a change amount adjusting unit 428.

The electric charge comparing unit 426 calculates a difference between electric charges Q2 and Q3, acquires a difference electric charge, and outputs the acquired difference electric charge to the distance calculating unit 427 and the change amount adjusting unit 428.

In other words, the electric charge comparing unit 426 acquires a difference voltage between output digital values OD(CS2) and OD(CS3) among output digital values OD(CS1), OD(CS2), and OD(CS3) respectively corresponding to electric charges Q1, Q2, and Q3 supplied from a distance image sensor 32. Also in this embodiment, for a pixel signal of a predetermined pixel in an abstract area (for example, a pixel of a center or a center of gravity of the abstract area) set for a distance image by a user or an average value of pixel signals of pixels in an abstract area, a difference voltage between the output digital values OD(CS2) and OD(CS3) is acquired.

Similar to the first embodiment, the distance calculating unit 427 acquires a distance D to a subject S for each pixel circuit 321 within a light receiving pixel unit 320 using Equation (1) or Equation (6) represented below. In Equation (6) represented below, Tc is a phase adjustment time for adjusting the phase of a light pulse PO (details thereof will be described below).

D=(c/2)Tc+(Q3′−Q1)/(Q2′+Q3′−2Q1)×Dm (6)

The distance calculating unit 427 selects one of Equation (1) and Equation (2) to be used for calculating a distance D on the basis of a difference voltage supplied from the electric charge comparing unit 426. Here, the distance calculating unit 427 uses Equation (6) for calculating the distance D in a case in which the difference voltage is “0” and uses Equation (1) for calculating the distance D in a case in which the difference voltage is not “0”.

The change amount adjusting unit 428 acquires an adjustment amount of a phase (timing) for emitting the light pulse PO in correspondence with a difference voltage supplied from the electric charge comparing unit 426.

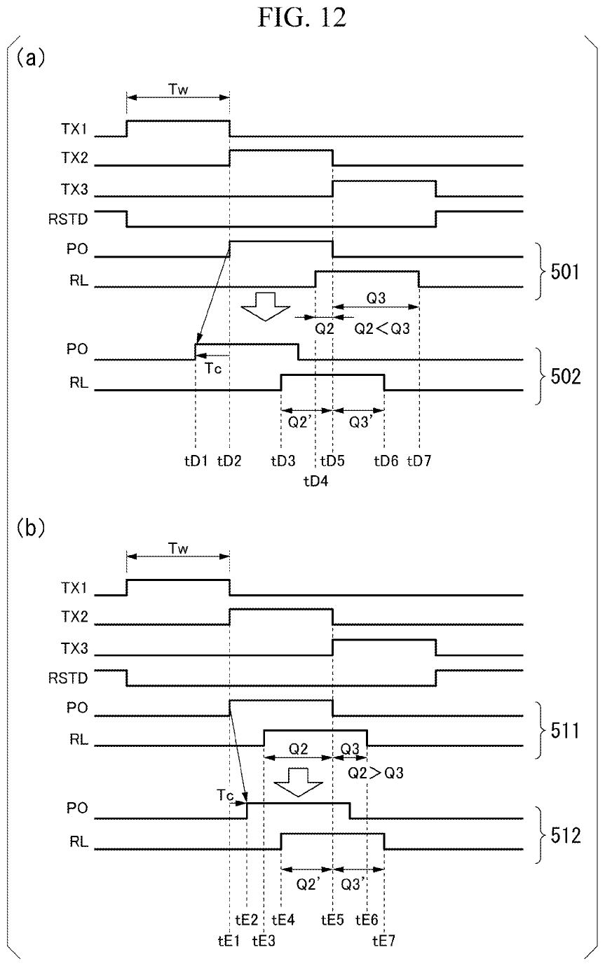

FIG. 12 is a diagram illustrating adjustment of a phase for outputting a light pulse PO that is performed by the change amount adjusting unit 428 according to this embodiment.

In subsection (a) of FIG. 12, when electric charges Q2 and Q3 are to be adjusted to be the same, in a case in which the electric charge Q2 is smaller than the electric charge Q3, the electric charge Q2 needs to be increased. For this reason, in order to increase the electric charge Q2, a distance between the distance image sensor 32 and the subject S may be considered to be shortened. In other words, by leading a timing for emitting the light pulse PO by a predetermined time (causing the phase to lead), it corresponds to substantially shortening the distance between the distance image sensor 32 and the subject S. In an area 501, a phase (a time tD2-tD5; the same phase as an accumulation drive signal TX2) with which the light pulse PO before timing adjustment is emitted and a phase (a time tD4-tD7) of reflected light RL from the subject S are shown. In addition, in an area 502, a phase (a time tD1) with which the light pulse PO after timing adjustment is emitted and a phase (a time tD3-tD6) of reflected light RL from the subject S are shown.

For this reason, the change amount adjusting unit 428 acquires an amount of adjustment of a phase corresponding to a numerical value of a difference voltage and an adjustment time Tc for leading the phase. Then, the change amount adjusting unit 428 outputs a control signal directing timing control of emission of the light pulse PO including the adjustment time Tc to the timing control unit 41.

In accordance with this, the timing control unit 41 leads the timing for outputting the light pulse PO from the time tD2 to the time tD1 by the adjustment time Tc.

By leading the phase as described above, the electric charge Q2 is increased, and the electric charge Q3 is decreased, whereby electric charges Q2′ and Q3′ acquired by adjusting the electric charges Q2 and Q3 to be the same can be acquired.

By increasing the electric charge Q2, in a case in which Equation (1) is used, the distance D to the subject S is calculated to be relatively small. For this reason, as a correction value for leading the phase of emission of the light pulse PO by the adjustment time Tc, a distance (c/2)Tc that light reciprocates during the adjustment time Tc is added to Equation (6). At this time, a correction for increasing the distance is performed, and thus the polarity of the adjustment time Tc is “+”.

In accordance with the process described above, by substituting the same electric charges Q2′ and Q3′ into Equation (6), a distance D to the subject S at the time of causing the phase of emission of the light pulse PO to lead by the adjustment time Tc can be calculated.

In subsection (b) of FIG. 12, when electric charges Q2 and Q3 are to be adjusted to be the same, in a case in which the electric charge Q2 exceeds the electric charge Q3, the electric charge Q2 needs to be decreased. For this reason, in order to decrease the electric charge Q2, the distance between the distance image sensor 32 and the subject S may be considered to be lengthened. In other words, by lagging a timing for emitting the light pulse PO by a predetermined time (causing the phase to lag), it corresponds to substantially lengthening the distance between the distance image sensor 32 and the subject S. In an area 511, a phase (a time tE1-tE5; the same phase as an accumulation drive signal TX2) with which the light pulse PO before timing adjustment is emitted and a phase (a time tE3-tE6) of reflected light RL from the subject S are shown. In addition, in an area 512, a phase (a time tE2) with which the light pulse PO after timing adjustment is emitted and a phase (a time tE4-tE7) of reflected light RL from the subject S are shown.

For this reason, the change amount adjusting unit 428 acquires an amount of adjustment of a phase corresponding to a numerical value of a difference voltage and an adjustment time Tc for lagging the phase. Then, the change amount adjusting unit 428 outputs a control signal directing timing control of emission of the light pulse PO including the adjustment time Tc to the timing control unit 41.

In accordance with this, the timing control unit 41 lags the timing for outputting the light pulse PO from the time tE1 to the time tE2 by the adjustment time Tc.

By leading the phase as described above, the electric charge Q2 is decreased, and the electric charge Q3 is increased, whereby electric charges Q2′ and Q3′ acquired by adjusting the electric charges Q2 and Q3 to be the same can be acquired.

By decreasing the electric charge Q2, in a case in which Equation (1) is used, the distance D to the subject S is calculated to be relatively large. For this reason, as a correction value for lagging the phase of emission of the light pulse PO by the adjustment time Tc, a distance (c/2)Tc that light reciprocates during the adjustment time Tc is added to Equation (6). At this time, a correction for decreasing the distance is performed, and thus the polarity of the adjustment time Tc is “−”.

In accordance with the process described above, by substituting the same electric charges Q2′ and Q3′ into Equation (6), a distance D to the subject S at the time of causing the phase of emission of the light pulse PO to lag by the adjustment time Tc can be calculated.

When the signal intensity becomes high with respect to noise according to background light (shot noise), the S/N ratio is improved, and the distance resolution is enhanced. However, in a case in which ratios of signal intensities of one of the electric charges Q2 and Q3 and the other thereof are greatly different, as shown below, the noise becomes large, and distance resolution of a side having a lower ratio of the signal intensity decreases.

Case in which ratios of electric charge Q2:Q3=1:3

Noise=(1²+3²)^{1/2}=(10)^{1/2}≈3.16

Case in which ratios of electric charge Q2:Q3=2:2

Noise=(2²+2²)^{1/2}=(8)^{1/2}≈2.83

In this way, by adjusting the electric charges Q2 and Q3 to be the same, noise can be reduced.

As described above, according to this embodiment, when a distance D to a subject is measured, by adjusting the phase of the light pulse PO such that the electric charges Q2 and Q3 are the same for the distance D, the distance resolution is improved, and the distance to the subject S having higher accuracy can be acquired.

In this embodiment, although the electric charges Q2 and Q3 have been described as being adjusted to be the same, in other words, a difference voltage has been described as being 0, a configuration in which a different voltage range having a predetermined width is set in correspondence with the magnitude of noise that is allowable, and an adjustment time Tc is generated such that the difference voltage enters this difference voltage range may be employed.

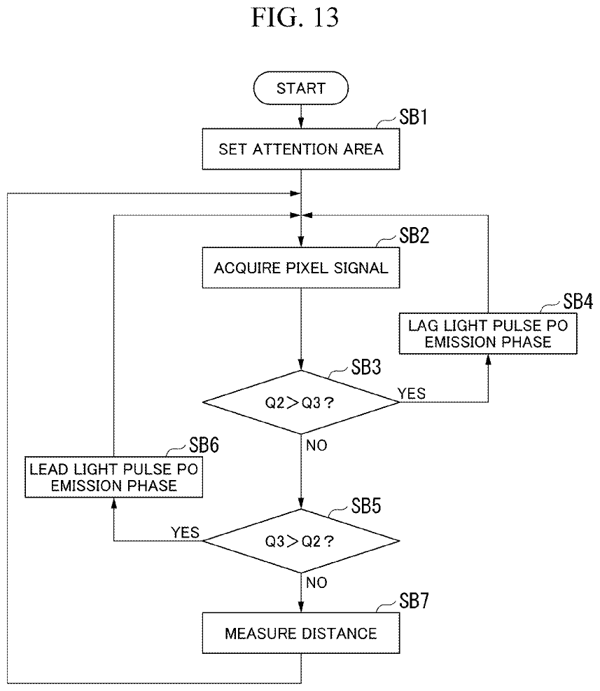

Hereinafter, the process of adjusting the phase of a light pulse PO in distance measurement of the distance image processing unit 4 according to this embodiment will be described with reference to FIG. 13. FIG. 13 is a flowchart illustrating an operation example of the process of adjusting the phase of the light pulse PO that is performed by the distance image capturing device 1 according to this embodiment. In the following distance measurement, adjustment of the phase of emission of a light pulse PO is performed using a pixel signal of an attention area in a distance image captured in units of frames by the distance image sensor 32, and the measurement is performed for pixel signals of all the pixel circuits 321 (for each frame of a captured image).

Step SB1: A user, for example, inputs information of an attention area (a distance measurement target) that is an area desired to be imaged in detail in a distance image to the distance image capturing device 1 using an input means not shown.

In addition, a configuration in which the information of the attention area described above in the distance image is set for the distance image capturing device 1 in advance, and the attention area set for the distance image is surrounded by a frame image may be employed. In such a case, a user adjusts the imaging direction of the distance image capturing device 1 such that a target for which a distance is to be measured (a target of attention) in detail by him/her enters the frame image described above. In the case of this configuration, when a target of attention is changed, the user performs the process of FIG. 13 by performing an operation indicating the change.

Step SB2: After acquiring pixel signals corresponding to one frame, the distance image sensor 32 sequentially outputs the pixel signals to the distance image processing unit 4.

Then, the electric charge comparing unit 426 extracts pixel signals corresponding to a set attention area from a distance image (pixel signals of all the pixel circuits 321 corresponding to one frame) supplied from the distance image sensor 32 (acquisition of pixel signals).

Step SB3: The electric charge comparing unit 426 performs comparison between the electric charges Q2 and Q3 in the pixel signals of the attention area, in other words, comparison between the output digital values OD(CS2) and OD(CS3). Here, the electric charge comparing unit 426 determines whether or not the output digital value OD(CS2) exceeds the output digital value OD(CS3).

At this time, in a case in which the output digital value OD(CS2) exceeds the output digital value OD(CS3), the electric charge comparing unit 426 causes the process to proceed to Step SB4. On the other hand, in a case in which the output digital value OD(CS2) does not exceed the output digital value OD(CS3) (in a case in which the output digital value OD(CS2) is equal to the output digital value OD(CS3), or the output digital value OD(CS2) is less than the output digital value OD(CS3)), the electric charge comparing unit 426 causes the process to proceed to Step SB5.

Step SB4: The electric charge comparing unit 426 acquires a difference voltage (a positive polarity at this time) between the output digital value OD(CS2) and the output digital value OD(CS3) and outputs the acquired difference voltage to the change amount adjusting unit 428.

For example, by referring to a correspondence table in which a correspondence between the difference voltage and the adjustment time Tc is described, the change amount adjusting unit 428 extracts and acquires an adjustment time Tc corresponding to the difference voltage supplied from the electric charge comparing unit 426.

In addition, a configuration in which a calculation equation for calculating an adjustment time Tc from each difference voltage is generated in advance through experiments or the like, and the change amount adjusting unit 428 calculates an adjustment time Tc by substituting a difference voltage supplied from the electric charge comparing unit 426 into this calculation equation may be employed.

At this time, the output digital value OD(CS2) exceeds the output digital value OD(CS3), and thus the difference voltage comes to have a positive polarity, and the change amount adjusting unit 428 acquires the adjustment time Tc as a time for lagging the phase of the light pulse PO.

Then, the change amount adjusting unit 428 adds the adjustment time Tc to a control signal directing timing control of emission of the light pulse PO and outputs a resultant control signal to the timing control unit 41.

In accordance with this, the timing control unit 41 emits the light pulse PO from the light source device 21 with being lagged by the adjustment time Tc. In addition, the change amount adjusting unit 428 outputs the adjustment time Tc to the distance calculating unit 427.

Step SB5: The electric charge comparing unit 426 performs comparison between the output digital values OD(CS2) and OD(CS3) in each pixel signal of the attention area. Here, the electric charge comparing unit 426 determines whether or not the output digital value OD(CS3) exceeds the output digital value OD(CS2).

At this time, in a case in which the output digital value OD(CS3) exceeds the output digital value OD(CS2), the electric charge comparing unit 426 causes the process to proceed to Step SB6. On the other hand, in a case in which the output digital value OD(CS3) does not exceed the output digital value OD(CS2) (in a case in which the output digital value OD(CS3) is equal to the output digital value OD(CS2)), the electric charge comparing unit 426 causes the process to proceed to Step SB7.

Step SB6: The electric charge comparing unit 426 acquires a difference voltage (at this time, a negative polarity) between the output digital value OD(CS2) and the output digital value OD(CS3) and outputs the acquired difference voltage to the change amount adjusting unit 428.

For example, by referring to a correspondence table in which a correspondence between the difference voltage and the adjustment time Tc is described, the change amount adjusting unit 428 extracts and acquires an adjustment time Tc corresponding to the difference voltage supplied from the electric charge comparing unit 426.

In addition, a configuration in which a calculation equation for calculating an adjustment time Tc from each difference voltage is generated in advance through experiments or the like, and the change amount adjusting unit 428 calculates an adjustment time Tc by substituting a difference voltage supplied from the electric charge comparing unit 426 into this calculation equation may be employed.

At this time, the output digital value OD(CS3) exceeds the output digital value OD(CS2), and thus the difference voltage comes to have a negative polarity, and the change amount adjusting unit 428 acquires the adjustment time Tc as a time for leading the phase of the light pulse PO.

Then, the change amount adjusting unit 428 adds the adjustment time Tc to a control signal directing timing control of emission of the light pulse PO and outputs a resultant control signal to the timing control unit 41.

In accordance with this, the timing control unit 41 emits the light pulse PO from the light source device 21 with being led by the adjustment time Tc. In addition, the change amount adjusting unit 428 outputs the adjustment time Tc to the distance calculating unit 427.

Step SB7: The distance calculating unit 427 calculates the distance D by substituting the adjustment time Tc for adjustment of the phase of the light pulse PO, the electric charge Q1 (the output digital value OD(CS1)), the electric charge Q2′ (the output digital value OD(CS2)), and Q3′ (the output digital value OD(CS3)) into Equation (6) in all the pixel signals in the frame.

In addition, the adjustment of the phase with which the light pulse PO is emitted in this embodiment may be configured to be performed after mode selection of the short-distance mode and the long-distance mode of the attention area in the first embodiment.

In addition, for the distance calculating unit 42 according to the first embodiment, the electric charge comparing unit 426 and the change amount adjusting unit 428 according to this embodiment are added.

Then, the configuration of the distance calculating unit 42 according to the first embodiment detects that a sub-measurement range is selected as the detailed measurement mode, and a subject S of an attention area is located in one of the short-distance range and the long-distance range.

Then, the electric charge comparing unit 426 performs comparison between the electric charges Q2 and Q3 and adjusts the phase of emission of the light pulse PO in correspondence with the detailed measurement mode.

For example, in the case of the short-distance mode shown in subsection (b) of FIG. 7, the process of leading or lagging the phase of the light pulse PO by the adjustment time Tc from a time tB2 as a base point is performed. In the case of the long-distance mode shown in subsection (c) of FIG. 7, the process of leading or lagging the phase of the light pulse PO by the adjustment time Tc from a time tB1 as a base point is performed. At this time, similar to Equation (6), (c/2)Tc is added as a correction distance to each of Equation (3) and Equation (4) used for the respective detailed measurement modes.

In this way, by adding a configuration for adjusting the phase of the light pulse PO according to the second embodiment to the distance calculating unit 42 according to the first embodiment, a distance D between the distance image capturing device 1 and the subject S can be measured with resolution having accuracy higher than that of the first embodiment.

### Third Embodiment

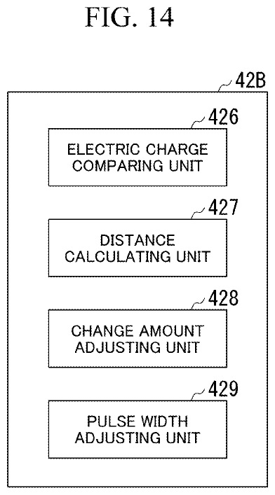

Hereinafter, a third embodiment of the present invention will be described with reference to the drawings. FIG. 14 is a block diagram illustrating an example configuration of a distance calculating unit 42B of a distance image processing unit 4 according to this embodiment. Hereinafter, configurations and operations different from those of the second embodiment will be described.

The distance calculating unit 42B shown in FIG. 14 includes an electric charge comparing unit 426, a distance calculating unit 427, a change amount adjusting unit 428, and a pulse width adjusting unit 429. Here, the electric charge comparing unit 426, the distance calculating unit 427, and the change amount adjusting unit 428 are similar to the configuration of the distance calculating unit 42A according to the second embodiment.

The pulse width adjusting unit 429 adjusts pulse widths (also including phases) of accumulation drive signals TX1, TX2, and TX3 in correspondence with the ratio between the electric charges Q2 and Q3. In addition, the width of the light pulse PO is fixed to a pulse width Tw.

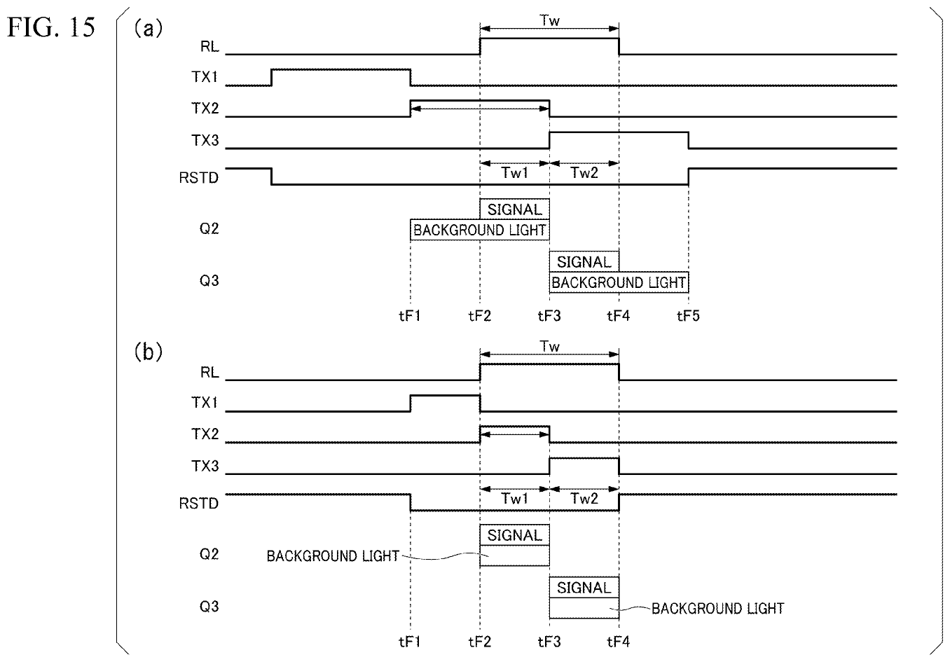

FIG. 15 is a diagram illustrating adjustment of the pulse widths of the accumulation drive signals TX1, TX2, and TX3 according to this embodiment.

Subsection (a) of FIG. 15 illustrates electric charge generated in accordance with background light and electric charge generated in accordance with reflected light RL at the time when the electric charges Q2 and Q3 are the same.

Subsection (b) of FIG. 15 illustrates electric charge generated in accordance with background light and electric charge generated in accordance with reflected light RL after adjustment of the pulse widths of the accumulation drive signals TX1, TX2, and TX3.

In subsection (a) of FIG. 15, the accumulation drive signal TX2 rises at a time tF1 and falls at a time tF3. In addition, the accumulation drive signal TX3 rises at a time tF3 and falls at a time tF5.

Here, the pulse width adjusting unit 429 determines the phase (time tF2-tF4) of reflected pulse PL using the ratio between the electric charges Q2 and Q3, in other words, the ratio between the output digital values OD(CS2) and OD(CS3). In accordance with this, pulse widths TX1 (time tF2-tF3) and TX2 (time tF3-tF4) are acquired using the time tF3 as the reference. Here, Tw=Tw1+Tw2

In subsection (b) of FIG. 15, the pulse width adjusting unit 429 performs adjustment of pulse widths of the accumulation drive signals TX1, TX2, and TX3 in correspondence with the phase of the reflected light RL. In addition, as described in the second embodiment, the phase of the light pulse PO is adjusted such that the electric charges Q2 and Q3 are the same, and thus Tw1=Tw2=Tw/2.

In this way, the pulse width adjusting unit 429 sets the pulse widths of the accumulation drive signals TX1, TX2, and TX3 to Tw/2 and outputs a control signal causing the timing control unit 41 to perform control of the phases of the accumulation drive signals TX1, TX2, and TX3 using the time tF3 as the reference.

In accordance with this, the timing control unit 41 performs control of the distance image sensor 32 such that it sets the pulse widths of the accumulation drive signals TX1, TX2, and TX3 to Tw/2, the accumulation drive signal TX1 rises at the time tF1 and falls at the time tF2, the accumulation drive signal TX2 rises at the time tF2 and falls at the time tF3, and the accumulation drive signal TX3 rises at the time tF3 and falls at the time tF4.

According to the configuration described above, as shown in FIG. 15, before and after the adjustment of pulse widths is performed, the electric charge generated in accordance with the background light can be reduced without decreasing the electric charge generated in accordance with the reflected light RL. In other words, shot noise can be reduced, and, even in a case in which the background light is strong, reduction of accuracy of distance measurement using the reflected light RL can be inhibited.

In addition, a margin in the accumulation electric charge of the electric charge accumulating unit CS is formed by decreasing the electric charge generated in accordance with background light, and the pulse widths of the accumulation drive signals TX1, TX2, and TX3 are shortened, and thus the number of times of distribution per frame can be increased without changing the frame period, the ratio of the electric charge according to the reflected light RL to a total electric charge is increased, and the S/N ratio is improved, whereby accuracy of measurement of the distance D can be improved.

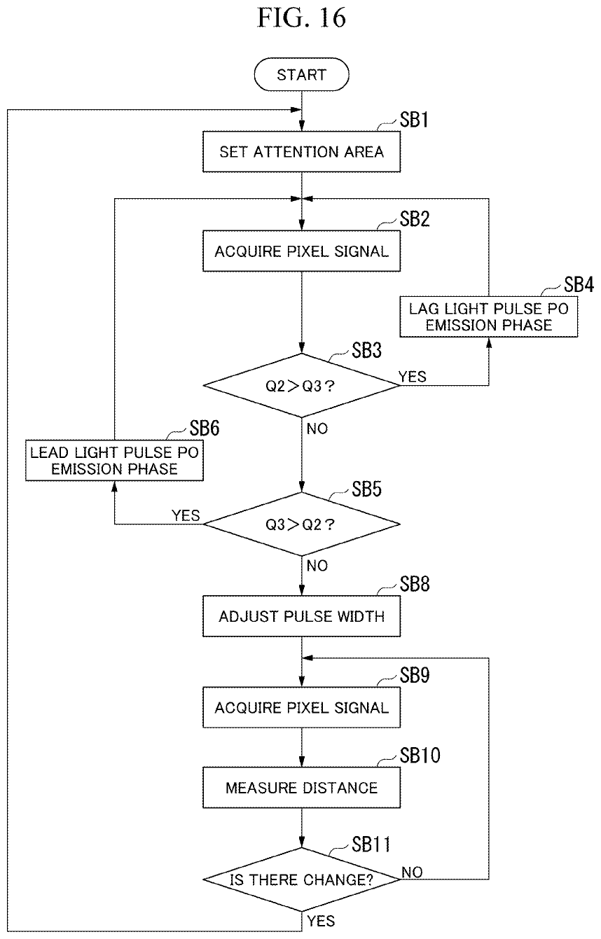

Hereinafter, the process of adjusting the pulse widths of the accumulation drive signals TX1, TX2, and TX3 in distance measurement of the distance image processing unit 4 according to this embodiment will be described with reference to FIG. 16. FIG. 16 is a flowchart illustrating an operation example of the process of adjusting the pulse widths of the accumulation drive signals TX1, TX2, and TX3 that is performed by the distance image capturing device 1 according to this embodiment. In the following distance measurement, adjustment of a phase of emission of a light pulse PO and adjustment of pulse widths of accumulation drive signals TX1, TX2, and TX3 are performed using pixel signals of an attention area in a distance image captured by the distance image sensor 32, and the measurement is performed for pixels signals of all the pixel circuits 321 (for each frame of the captured image). Steps SB1 to SB6 are operations similar to those according to the second embodiment, and thus a description thereof will be omitted.

Step SB8: The pulse width adjusting unit 429 extracts pixel signals in an attention area among pixel signals supplied from the distance image sensor 32 for each frame period.

Then, the pulse width adjusting unit 429 compares output digital values OD(CS2) and OD(CS3) with each other and, as shown with reference to FIG. 15 above, performs the process of adjusting the pulse widths and phases of the accumulation drive signals TX1, TX2, and TX3.

Then, the timing control unit 41 causes the distance image sensor 32 to adjust the pulse widths and the phases of the accumulation drive signals TX1, TX2, and TX3 such that the accumulation drive signals TX2 and TX3 are included in the pulse width Tw of the reflected light RL with the same phase as that of the reflected light RL shown in subsection (b) of FIG. 15.

Step SB9: After acquiring pixel signals corresponding to one frame, the distance image sensor 32 sequentially outputs the pixel signals to the distance image processing unit 4.

In accordance with this, the distance calculating unit 427 inputs the distance image (pixel signals of all the pixel circuits 321 corresponding to one frame) supplied from the distance image sensor 32 (acquisition of pixel signals).

Step SB10: The distance calculating unit 427 acquires a distance D to the subject S by respectively substituting output digital values OD(CS1), OD(CS2), and OD(CS3) of input pixel signals into Equation (6) as electric charges Q1, Q2′, and Q3′.

Step SB11: The pulse width adjusting unit 429 determines whether or not an operation indicating change of the attention area has been performed from an input means by a user.

At this time, in a case in which a changing operation has been performed, the pulse width adjusting unit 429 causes the process to proceed to Step SB1. On the other hand, in a case in which no changing operation has been performed, the pulse width adjusting unit 429 causes the process to proceed to Step SB9.

In addition, the pulse width adjusting unit 429 may be configured to compare a measured distance D with a distance D that has been measured immediately before and return the process to Step SB1 due to movement of the subject S in the attention area in a case in which there is a change exceeding a predetermined threshold.

As above, although the embodiments of the present invention have been described with reference to the drawings, a specific configuration is not limited to these embodiments, and a design and the like in a range not departing from the concept of the present invention are included therein.

### REFERENCE SIGNS LIST

1 distance image capturing device

2 light source unit

3 light receiving unit

4 distance image processing unit

21 light source device

22 diffusion plate

31 lens

32 distance image sensor

41 timing control unit

42, 42A, 42B distance calculating unit

320 light receiving pixel unit

321 pixel circuit

322 control circuit

323 vertical scanning circuit

324 horizontal scanning circuit

325 pixel signal processing circuit

326 pixel driving circuit

329 AD conversion circuit

329j column AD conversion unit

329j(CS1), 329j(CS2), 329j(CS3) column AD conversion circuit

420 electric charge determining unit

421, 427 distance calculating unit

422 distance determining unit

423 mode setting unit

424 measurability/non-measurability unit

425 mode table

426 electric charge comparing unit

428 change amount adjusting unit

429 pulse width adjusting unit

C electric charge accumulation capacitor

CS electric charge accumulating unit

FD floating diffusion

G reading gate transistor

GD drain gate transistor

O output terminal

P measurement space

PD photo electric conversion device

PO light pulse

RL reflected light

RT reset gate transistor

RU pixel signal reading unit

S object

SF source follower gate transistor

SL selection gate transistor

1. A distance image capturing device comprising:
a light source unit which radiates radiation light into a measurement space that is a space to be measured;
a light receiving pixel unit which comprises:
a photo electric conversion device that receives reflected light which the radiation light has been reflected from an object in the measurement space and background light in an environment of the measurement space, and that generates an electric charge in accordance with the received reflected light and the background light; and
an electric charge accumulating unit which accumulates the electric charge when the radiation light is irradiated in a frame period; and
wherein the light receiving pixel unit includes a pixel circuit that accumulates the electric charge in the electric charge accumulating unit in synchronization with irradiation of the radiation light, and
a distance image processing unit, when the distance is measured by an input voltage in accordance with an electric charge accumulated in the electric charge accumulating unit, that:
measures a distance via a normal mode at a predetermined width of radiation light when the distance is measured by an input voltage in accordance with an electric charge accumulated in the electric charge accumulating unit, and
switches to the detailed measurement mode according to the distance to the object measured via the normal mode and adjusts a width together with a phase of the radiation light radiated from the light source unit by a detailed measurement mode.

2. (canceled)

3. The distance image capturing device according to claim 1, wherein a distance range that is a range of a distance that is capable of being measured in the normal mode is divided into a plurality of sub-measurement ranges having the same width in the detailed measurement mode, the width of the radiation light is set in correspondence with a corresponding sub-measurement range, and the phase of the radiation light is set in correspondence with a minimum distance in the sub-measurement range; and
after measuring the distance via the normal mode, the distance image processing unit performs distance measurement via the detailed measurement mode that uses a width and a phase of radiation light set in correspondence with the sub-measurement range in which the distance acquired in the measurement is included.

4. (canceled)

5. The distance image capturing device according to claim 3, wherein the distance image processing unit acquires a distance to the object present in the measurement space on the basis of an electric charge that is an electric charge distributed for a fixed number of times of distribution of electric charge set in advance in the normal mode and accumulated in each of a plurality of distributed electric charge accumulating units of the electric charge accumulating unit and, after measuring the distance in the normal mode, performs distance measurement via the detailed measurement mode on the basis of the electric charge for the number of times of distribution of electric charge set in correspondence with the sub-measurement range in which the distance acquired in the measurement is included.

6. The distance image capturing device according to claim 1, wherein the distance image processing unit adjusts an intensity of the radiation light emitted from the light source unit in correspondence with the distance to the object.

7. The distance image capturing device according to claim 1, wherein, in a case in which the distance to the object is acquired on the basis of the ratio between electric charges that are electric charges accumulated in a first distributed electric charge accumulating unit and a second distributed electric charge accumulating unit that are two electric charge accumulating units accumulating electric charge of the reflected light, the distance image processing unit, after switching to the detailed measurement mode, switches to the normal mode without performing a process of acquiring a distance in a case in which the electric charge according to the reflected light in one of the first distributed electric charge accumulating unit and the second distributed electric charge accumulating unit is equal to or smaller than an electric charge threshold set in advance.

8. The distance image capturing device according to claim 7, wherein the electric charge threshold is an electric charge accumulated in a background light electric charge accumulating unit in accordance with background light.

9. The distance image capturing device according to claim 1, wherein, in a case in which the distance to the object is acquired on the basis of the ratio between electric charges that are electric charges accumulated in a first distributed electric charge accumulating unit and a second distributed electric charge accumulating unit that are two electric charge accumulating units accumulating electric charge of the reflected light, the distance image processing unit, after measuring a distance via the normal mode, adjusts the phase of the radiation light such that electric charges of the first distributed electric charge accumulating unit and the second distributed electric charge accumulating unit are the same and acquires the distance on the basis of the electric charges and an amount of adjustment of the phase.

10. The distance image capturing device according to claim 9, wherein,
after the adjustment of the phase of the radiation light is performed and the electric charges are the same, the distance image processing unit adjusts widths of accumulation drive signals for distributing electric charge to the first distributed electric charge accumulating unit and the second distributed electric charge accumulating unit such that there is no area in which electric charge according to the reflected light is not included.

11. A distance image capturing method comprising:
a process of radiating radiation light from a light source unit to a measurement space that is a space to be measured;
a process of receiving reflected light which the radiation light has been reflected from an object in the measurement space and background light in an environment of the measurement space and generating an electric charge in accordance with the received reflected light and the background light using a photo electric conversion device;
a process of accumulating the electric charge according to the reflected light in an electric charge accumulating unit in synchronization with radiation of the irradiation light in a frame period;
a process of measuring a distance via a normal mode at a predetermined width of radiation light when the distance is measured by an input voltage in accordance with an electric charge accumulated in the electric charge accumulating unit; and
adjusting a width together with a phase of the radiation light radiated from the light source unit by a detailed measurement mode, wherein the detailed measurement mode is switched according to the distance to the object measured via the normal mode.
